(19) United States
(12) Patent Application Publication
(10) Pub. No.: US 2026/0288874 A1
(43) Pub. Date: Sep. 24, 2026

(54) RECOMMENDATION META-MODEL

(71) Applicant: Tencent Technology (Shenzhen) Company Limited, Shenzhen (CN)

(72) Inventor: Jiawei ZHENG, Shenzhen (CN)

(73) Assignee: Tencent Technology (Shenzhen) Company Limited, Shenzhen (CN)

(21) Appl. No.: 19/183,200

(22) Filed: Apr. 18, 2025

Related U.S. Application Data
(63) Continuation of application No. PCT/CN2023/129601, filed on Nov. 3, 2023.

(30) Foreign Application Priority Data
Feb. 6, 2023 (CN) 202310127618.3

(51) Int. Cl. G06F 16/9035

(52) U.S. Cl. CPC G06F 16/9035

(57) ABSTRACT

In a model training method, a heterogeneous data structure that includes a plurality of nodes is obtained. Data corresponding to each of the nodes includes an object and an attribute of the object. An object node corresponding to a target object, an interaction node corresponding to an interaction object that interacts with the target object, and an attribute node corresponding to an attribute of the target object are obtained from the plurality of nod. An object feature that is extracted from the object node, an interaction feature that is extracted from the interaction node, and an attribute feature that is extracted from the attribute node are obtained. The object feature, the interaction feature, and the attribute feature are fused to obtain a sample node feature of the target object. A candidate recommendation meta-model is trained according to the sample node feature, to obtain a trained recommendation meta-model.

### RELATED APPLICATIONS

The present application is a continuation of International Application No. PCT/CN2023/129601, filed on Nov. 3, 2023, which claims priority to Chinese Patent Application No. 202310127618.3, filed on Feb. 6, 2023. The entire disclosures of the prior applications are hereby incorporated by reference.

### FIELD OF THE TECHNOLOGY

This disclosure relates to the field of data processing, including to a model training method and apparatus, an electronic device, a storage medium, and a computer program product.

### BACKGROUND OF THE DISCLOSURE

With the development of science and technology, data on the Internet is increasing. A recommendation system can be used to help a user find data more easily. The recommendation system may recommend data to the user according to existing interaction data between the user and an item.

In a related technology, the recommendation system recommends data to the user according to the interaction data by using a collaborative filtering algorithm. However, in the collaborative filtering algorithm, a large amount of existing interaction data needs to be relied on. If the amount of existing interaction data is relatively small, a new item cannot be recommended to the user, or an item cannot be recommended to a new user. Consequently, recommendation accuracy can be relatively low.

### SUMMARY

Embodiments of this disclosure provide a model training method and apparatus, an electronic device, a computer-readable storage medium, and a computer program product, to improve accuracy of recommendation based on a recommendation meta-model obtained by training.

Embodiments of this disclosure provide a model training method. In the model training method, a heterogeneous data structure that includes a plurality of nodes is obtained. Data corresponding to each of the nodes includes an object and an attribute of the object. An object node corresponding to a target object, an interaction node corresponding to an interaction object that interacts with the target object, and an attribute node corresponding to an attribute of the target object are obtained from the plurality of nodes of the heterogeneous data structure. An object feature that is extracted from the object node, an interaction feature that is extracted from the interaction node, and an attribute feature that is extracted from the attribute node are obtained. The object feature, the interaction feature, and the attribute feature are fused to obtain a sample node feature of the target object. A candidate recommendation meta-model is trained according to the sample node feature, to obtain a trained recommendation meta-model.

Embodiments of this disclosure provide a model training apparatus, including processing circuitry. The processing circuitry is configured to obtain a heterogeneous data structure that includes a plurality of nodes, data corresponding to each of the nodes including an object and an attribute of the object. The processing circuitry is configured to obtain, from the plurality of nodes of the heterogeneous data structure, an object node corresponding to a target object, an interaction node corresponding to an interaction object that interacts with the target object, and an attribute node corresponding to an attribute of the target object. The processing circuitry is configured to obtain an object feature that is extracted from the object node, an interaction feature that is extracted from the interaction node, and an attribute feature that is extracted from the attribute node. The processing circuitry is configured to fuse the object feature, the interaction feature, and the attribute feature to obtain a sample node feature of the target object. The processing circuitry is configured to train, according to the sample node feature, a candidate recommendation meta-model to obtain a trained recommendation meta-model.

Furthermore, embodiments of this disclosure further provide an electronic device, including a processor and a memory. The memory has a computer program stored. The processor is configured to run the computer program in the memory to implement the model training method or object recommendation method provided in embodiments of this disclosure.

Furthermore, embodiments of this disclosure further provide a computer-readable storage medium. The computer-readable storage medium has a computer program stored. The computer program is suitable for being loaded by a processor to perform any model training method or object recommendation method provided in embodiments of this disclosure.

Furthermore, embodiments of this disclosure further provide a computer program product, including a computer program. The computer program, when executed by a processor, implements the model training method or object recommendation method provided in embodiments of this disclosure.

In embodiments of this disclosure, a heterogeneous data structure including a plurality of nodes is obtained, where data corresponding to each node includes an object and an attribute of the object. An object node corresponding to a target object, an interaction node corresponding to an interaction object that interacts with the target object, and an attribute node corresponding to an attribute of the target object are obtained from the heterogeneous data structure. Feature extraction is performed on the object node, the interaction node, and the attribute node, respectively, to obtain an object feature corresponding to the object node, an interaction feature corresponding to the interaction node, and an attribute feature corresponding to the attribute node. The object feature, the interaction feature, and the attribute feature are fused to obtain a sample node feature of the target object. A candidate recommendation meta-model is trained according to the sample node feature to obtain a trained recommendation meta-model.

A meta-model may rapidly and accurately learn a small amount of data. Therefore, even if there are few interaction nodes corresponding to the object node in the heterogeneous data structure (to be specific, there is a small amount of interaction data in a model training process), when the trained recommendation meta-model obtained by training the candidate recommendation meta-model based on the heterogeneous data structure is recommended, a new item may be recommended to a user or an item may be recommended to a new user, thereby improving recommendation accuracy. Moreover, the sample node feature of the target object includes the attribute feature of the target object, and the sample node feature not only integrates the object feature and the interaction feature, but also integrates the attribute feature. Therefore, training the candidate recommendation meta-model by using the sample node feature enables objects having similar attribute features to have similar interaction parameters. Thus, when recommendation is performed by using the trained recommendation meta-model obtained by training, the item may be more accurately recommended to the user. Compared with a mode of recommendation using the recommendation model obtained by training in the related technology, recommendation using the trained recommendation meta-model obtained by training in embodiments of this disclosure improves the recommendation accuracy.

### BRIEF DESCRIPTION OF THE DRAWINGS

FIG. 1 is a schematic diagram of a scene of a model training process according to an embodiment of this disclosure.

FIG. 2 is a schematic flowchart of a model training method according to an embodiment of this disclosure.

FIG. 3 is a schematic diagram of a heterogeneous data structure according to an embodiment of this disclosure.

FIG. 4 is a schematic diagram of a neighbor node according to an embodiment of this disclosure.

FIG. 5 is a schematic diagram of a sub-heterogeneous data structure according to an embodiment of this disclosure.

FIG. 6 is a schematic diagram of meta-learning according to an embodiment of this disclosure.

FIG. 7 is a schematic diagram of a process of a model training method according to an embodiment of this disclosure.

FIG. 8 is a schematic diagram of an object recommendation method according to an embodiment of this disclosure.

FIG. 9 is a schematic diagram of a recommendation system according to an embodiment of this disclosure.

FIGS. 10A-10C include a schematic flowchart of another model training method according to an embodiment of this disclosure.

FIG. 11 is a schematic flowchart of a model application method according to an embodiment of this disclosure.

FIG. 12 is a schematic structural diagram of a model training apparatus according to an embodiment of this disclosure.

FIG. 13 is a schematic structural diagram of an object recommendation apparatus according to an embodiment of this disclosure.

FIG. 14 is a schematic structural diagram of an electronic device according to an embodiment of this disclosure.

### DESCRIPTION OF EMBODIMENTS

The technical solutions in embodiments of this disclosure are described in the following with reference to the accompanying drawings in embodiments of this disclosure. The described embodiments are merely some rather than all of the embodiments of this disclosure. Other embodiments are within the scope of this disclosure.

Embodiments of this disclosure provide a model training method and apparatus, an electronic device, a computer-readable storage medium, and a computer program product. The model training apparatus may be integrated in an electronic device, and the electronic device may be a server or a device such as a terminal. Descriptions of terms in this disclosure are provided as examples only and are not intended to limit the scope of the disclosure.

The server may be an independent physical server, or a server cluster or distributed system composed of a plurality of physical servers, or may be a cloud server for providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence (AI) platform.

Moreover, a plurality of servers may be grouped into a blockchain, and the servers are nodes on the blockchain.

The terminal may be a smartphone, a tablet computer, a notebook computer, a desktop computer, a smart speaker, a smartwatch, or the like, but is not limited thereto. The terminal and the server may be directly or indirectly connected in a wired or wireless communication mode. This is not limited in embodiments of this disclosure.

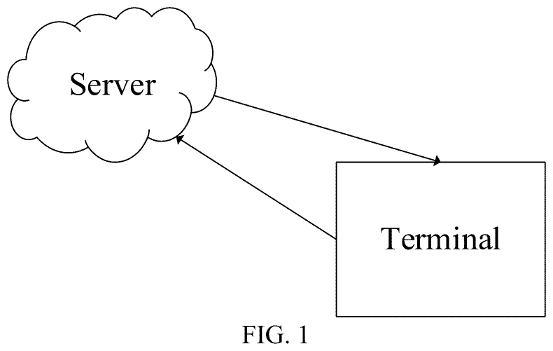

For example, as shown in FIG. 1, the server may generate a heterogeneous data structure according to data in a recommendation system, and transmit the heterogeneous data structure to the terminal. The terminal then screens out an object node corresponding to a target object in objects and a neighbor node of the object node from the heterogeneous data structure. The neighbor node includes an interaction node corresponding to an interaction object that interacts with the target object and an attribute node corresponding to an attribute of the target object. Feature extraction is performed on the object node and the neighbor node, respectively, to obtain an object feature corresponding to the object node, an interaction feature corresponding to the interaction node, and an attribute feature corresponding to the attribute node. The object feature, the interaction feature, and the attribute feature are fused to obtain a sample node feature of the target object. A candidate recommendation meta-model is trained according to the sample node feature to obtain a trained recommendation meta-model. The terminal then transmits the trained recommendation meta-model to the server.

In addition, “a plurality” in embodiments of this disclosure refers to two or more. In embodiments of this disclosure, “first” and “second” are configured for distinguishing description, and cannot be understood as implying relative importance.

AI is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganizes an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

With the research and progress of an AI technology, the AI technology is researched and applied in many fields, such as common smart home, intelligent wearable devices, virtual assistants, intelligent speakers, intelligent marketing, unmanned driving, automatic driving, unmanned aerial vehicles, robots, intelligent medical, and intelligent customer service. It is believed that with the development of the technology, the AI technology will be applied in more fields and play an increasingly important value.

Detailed descriptions are separately provided below. A description order of the following embodiments is not used as a limitation on the priority order of the embodiments.

In this embodiment, for convenience of description, the model training method of this disclosure is described from the perspective of a model training apparatus. The model training apparatus is integrated in a terminal for detailed description below. To be specific, the terminal serves as an execution body for detailed description.

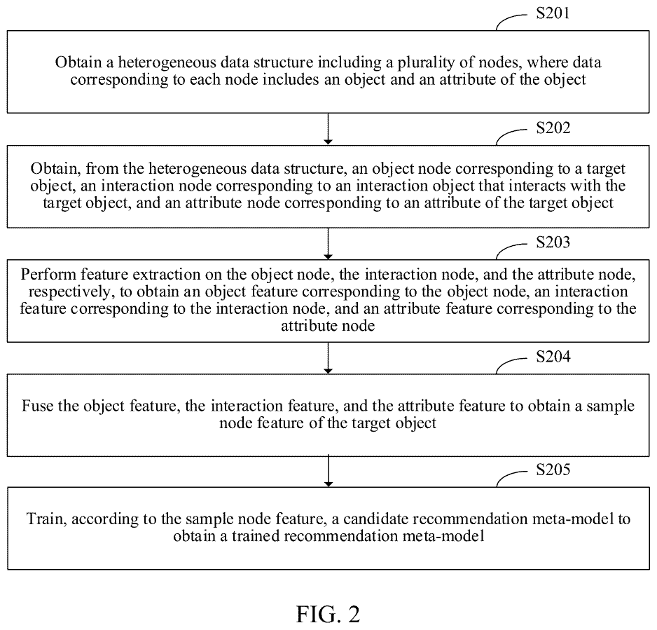

FIG. 2 is a schematic flowchart of a model training method according to an embodiment of this disclosure. In an actual application, the model training method may be independently implemented by a server or a terminal, or cooperatively implemented by a server and a terminal. In embodiments of this disclosure, the method is, for example, independently implemented by a server. The model training method may include the following operations.

S201: Obtain a heterogeneous data structure including a plurality of nodes, where data corresponding to each node includes an object and an attribute of the object.

Herein, the heterogeneous data structure may be generated according to data in a recommendation system. The recommendation system includes data (such as an identifier of a recommendation object, a number of recommendations, and an object attribute) of the recommendation object (such as a recommended item, where the item may be an actual item such as an apple, or a virtual item such as a video) and data (such as an identifier of a user object, a number of recommendations, and preference information of the user object) of a recommended object (such as the user object).

In an actual application, the heterogeneous data structure may be periodically generated according to the data in the recommendation system, to obtain the heterogeneous data structure. Alternatively, the heterogeneous data structure may be periodically generated according to the data in the recommendation system and then stored. Then, when a model training instruction for instructing to perform model training is obtained, the heterogeneous data structure is directly obtained from a storage space. Alternatively, when the model training instruction is obtained, the heterogeneous data structure may be generated according to the data in the recommendation system.

The heterogeneous data structure includes a plurality of nodes. Each node corresponds to one object. The object may be a recommendation object or a recommended object. Data or object data corresponding to each node includes the object (object identifier) and an attribute of the object.

The heterogeneous data structure is a network structure including nodes corresponding to a plurality of node types. In some embodiments, the node types may include items and users. For example, network structure g1 may be shown in FIG. 3. The network structure g1 includes node n1, node n2, and node n3. Node n1 represents shoe a1, node n2 represents user u1, and node n3 represents sports shoe t1 (a category of shoe a1). A node type of shoe a1 is an item, a node type of user u1 is a user, and a node type of node n3 is sports shoe t1, i.e. an attribute of shoe a1. Therefore, network structure g1 is the heterogeneous data structure.

The object may be an entity that may independently exist in the recommendation system, and may include at least one of an item (i.e. recommendation object) or a user (i.e. recommended object). The item may include a plurality of types. The type of the item may be selected according to an actual situation. For example, the item may include a commodity or a product. The product may be, for example, a video number, a livestreaming room, or an article. This is not limited in embodiments of this disclosure herein.

The attribute of the object is information indicating a property of the object. For example, when the object is an item, the attribute of the object may include a category of the item or a publisher of the item. For another example, when the object is a user, the attribute of the object may include an age or gender of the user.

S202: Obtain, from the heterogeneous data structure, an object node corresponding to a target object, an interaction node corresponding to an interaction object that interacts with the target object, and an attribute node corresponding to an attribute of the target object.

The interaction refers to a behavior that is performed by an object and acts on another object. A type of the interaction may be selected according to an actual situation. For example, a user clicks/taps an icon of an item. In this case, the interaction refers to clicking/tapping that is performed by the user and acts on the item. For another example, the user watches a video. To be specific, the user triggers a play instruction for the video. For example, the user clicks/taps a play control. In this case, the interaction refers to triggering, by the user, the play instruction for the video, and the watching is performed by the user and acts on the video. This is not limited in embodiments of this disclosure.

In the recommendation system, recommendation may be performed based on a user (to be specific, an item is recommended to a new user), or may be performed based on an item (to be specific, a new item is recommended to a user). When a new item is recommended to a user, the target object may be an item, and in this case, recommendation is performed based on the item. When an item is recommended to a new user, the target object may be a user, and in this case, recommendation is performed based on the user. When the target object is an item, the interaction object that interacts with the target object may be a user, and an attribute of the target object may be an attribute of the item. In this case, the heterogeneous data structure may include an attribute of the user or not. When the target object is a user, the interaction object that interacts with the target object may be an item, and an attribute of the target object may be an attribute of the user. In this case, the heterogeneous data structure may include an attribute of the item or not.

The server may first determine a node type corresponding to the target object, screen out an object node corresponding to the target object from the heterogeneous data structure according to the node type corresponding to the target object, and then screen out a neighbor node corresponding to the object node from the heterogeneous data structure. In an actual application, the interaction node and the attribute node may belong to a neighbor node of the object node.

Alternatively, the server may select, from the heterogeneous data structure, an object node corresponding to the target object in the objects and a neighbor node of the object node according to a preset meta-path. In this case, the process of obtaining, from the heterogeneous data structure, an object node corresponding to a target object, an interaction node corresponding to an interaction object that interacts with the target object, and an attribute node corresponding to an attribute of the target object may be:
obtaining a plurality of preset meta-paths, where the preset meta-paths include different node types; and
screening out, from the heterogeneous data structure, an object node corresponding to a target object in the objects, an interaction node corresponding to an interaction object that interacts with the target object, and an attribute node corresponding to an attribute of the target object according to the different node types.

The preset meta-path refers to a path connecting a plurality of nodes. The nodes in the path may include at least two node types. The path may describe association relationships between the plurality of nodes. Different preset meta-paths usually represent different semantic information. The type of the nodes in the preset meta-path may be set according to an actual situation. This is not limited in embodiments of this disclosure herein. For example, a preset meta-path p1 is item→user→item, semantic information represented by the preset meta-path p1 is that two items preferred by the same user may be similar, a preset meta-path p2 is item→attribute→item, and semantic information represented by the preset meta-path p2 is that two items with the same attribute may be similar.

Different attribute nodes may be stored in different or same preset meta-paths. The attribute node and the interaction node may be stored in the different or same preset meta-paths.

For example, when different attribute nodes are stored in different preset meta-paths, the preset meta-paths may be item→category→item and item→publisher→item. When different attribute nodes are stored in the same preset meta-path, the preset meta-path may be item→category→item→publisher→item.

When the attribute node and the interaction node are stored in different preset meta-paths, the preset meta-path including the attribute node may be item→attribute→item, and the preset meta-path including the interaction node may be item→user→item. When the attribute node and the interaction node are stored in the same preset meta-path, the preset meta-path may be item→attribute→item→user→item.

In some embodiments, after a preset meta-path is obtained, a node sequence corresponding to different types of nodes in the preset meta-path may be screened out from the heterogeneous data structure, and then an object node corresponding to the target object and a neighbor node of the object node are screened out from the node sequence.

For example, the preset meta-path may be item→attribute, a node sequence corresponding to different node types in the preset meta-path may be shoe a1→sports shoe, shoe a1 is selected from shoe a1→sports shoe as the object node, and a sports shoe is set as the neighbor node.

Alternatively, the preset meta-path includes a direction. Therefore, after obtaining the preset meta-path, the terminal may determine a start node type and an adjacent node type among different node types in the preset meta-path according to the direction in the preset meta-path, screen out a node corresponding to the start node type from the heterogeneous data structure to obtain an object node corresponding to the target object, obtain initial neighbor nodes corresponding to the object node, and screen out an initial neighbor node corresponding to the adjacent node type from the initial neighbor nodes to obtain the neighbor node of the object node.

For example, the preset meta-path may be item→attribute. The start node type is an item, the adjacent node type is an attribute, a node corresponding to the item is set as the object node of the target object, and an initial neighbor node corresponding to the attribute in the initial neighbor nodes of the object node is set as the neighbor node of the object.

At least one adjacent node type may be included. For example, when the preset meta-path is item→attribute, the adjacent node type is an attribute. In this case, one adjacent node type is included. For another example, when the preset meta-path is item→attribute→item, the adjacent node type is an attribute and an item. In this case, two adjacent node types are included.

To be specific, the process of screening out an initial neighbor node corresponding to the adjacent node type from the initial neighbor nodes to obtain a neighbor node of the object node may be:
screening out a next node type corresponding to the start node type from the adjacent node type to obtain an intermediate node type;
screening out an initial neighbor node corresponding to the intermediate node type from the initial neighbor nodes to obtain a candidate neighbor node of the object node;
setting, if an unscreened node type exists in the preset meta-path, an initial neighbor node of the candidate neighbor node as the initial neighbor node, setting the intermediate node type as the start node type, and returning to the operation of screening out a next node type corresponding to the start node type from the adjacent node type to obtain an intermediate node type; and
setting, if no unscreened node type exists in the preset meta-path, the candidate neighbor node of the object node as the neighbor node of the object node.

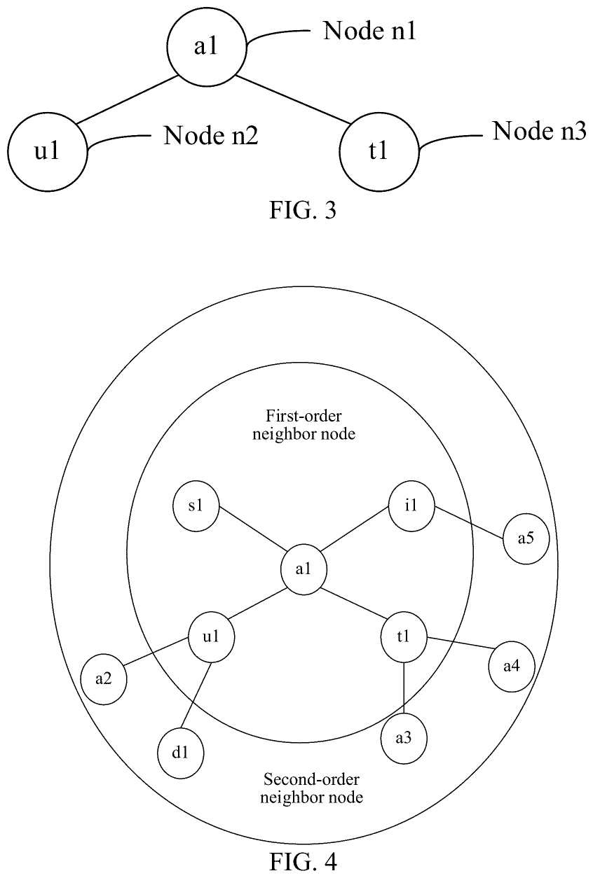

For example, as shown in FIG. 4, the preset meta-path is item→category→item. In this case, there are two adjacent node types. A node corresponding to the start node type is shoe a1, initial neighbor nodes of shoe a1 are user u1, sports shoe t1, publisher i1, and price s1, and a next node type to the start node type is a category. An initial neighbor node corresponding to the category is screened out from the initial neighbor nodes to obtain a candidate neighbor node “sports shoe t1” of shoe a1, and an initial neighbor node of the candidate neighbor node includes shoe a3 and shoe a4.

In this case, there is an unscreened node type “item” in the adjacent node types. Therefore, shoe a3 and shoe a4 are set as the initial neighbor nodes, the category is set as the start node type, a next node type to the category in the adjacent node types is an item, and initial neighbor nodes of the item are screened out from shoe a3 and shoe a4 to obtain a candidate neighbor node “shoe a3” and a candidate neighbor node “shoe a4” of the object node.

In this case, there is no unscreened node type in the adjacent node types. Therefore, the candidate neighbor node “sports shoe t1”, the candidate neighbor node “shoe a3”, and the candidate neighbor node “shoe a4” of the object node are set as neighbor nodes of the object node. To be specific, in this case, the neighbor node of the object node includes a first-order neighbor node and a second-order neighbor node of the object node.

A node may be a first-order neighbor node, or may be a second-order neighbor node. For example, as shown in FIG. 4, the node “shoe a4” is a first-order neighbor node of the node “sports shoe t1”, and is a second-order neighbor node of the node “shoe a1”.

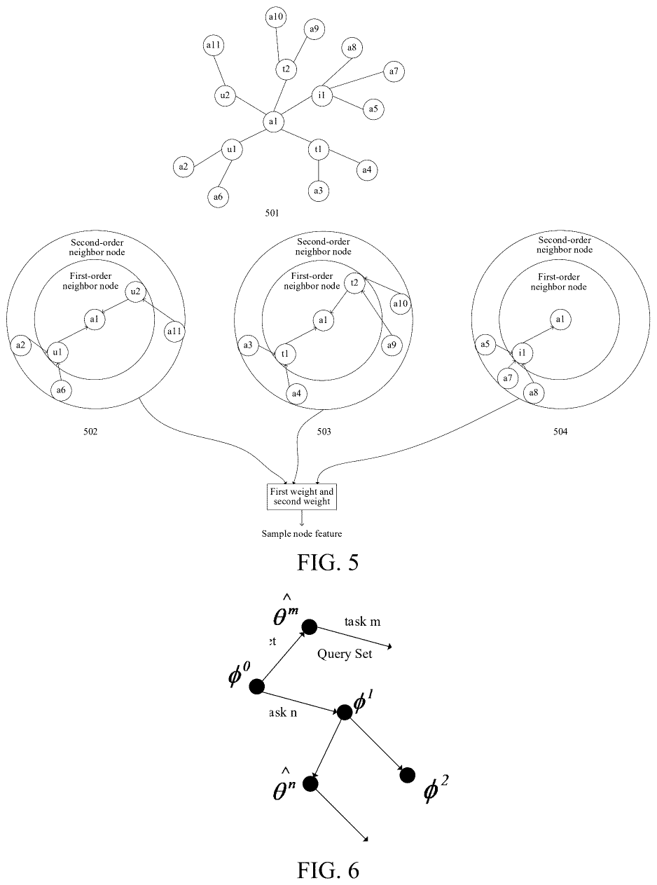

In some embodiments, the object node and the neighbor node obtained by using each preset meta-path may respectively form a sub-heterogeneous data structure. For example, the heterogeneous data structure may be shown as 501 in FIG. 5. The preset meta-path includes item→category→item, item→user→item, and item→publisher→item. Therefore, the sub-heterogeneous data structure obtained by using item→user→item may be shown as 502 in FIG. 5. The sub-heterogeneous data structure obtained by using item→category→item may be shown as 503 in FIG. 5. The sub-heterogeneous data structure obtained by using item→publisher→item may be shown as 504 in FIG. 5.

An edge in the sub-heterogeneous data structure may be a non-directional edge. Alternatively, to facilitate subsequent feature fusion processing, the edge in the sub-heterogeneous data structure may be a directional edge, and a direction of the directional edge may be an opposite direction of a direction of the preset meta-path.

For example, as shown in 502 in FIG. 5, shoe a1→user u2→shoe all may be obtained by using item→user→item, and the preset meta-path is represented as shoe all→user u2→shoe a1 in the sub-heterogeneous data structure corresponding to item→user→item.

S203: Perform feature extraction on the object node, the interaction node, and the attribute node, respectively, to obtain an object feature corresponding to the object node, an interaction feature corresponding to the interaction node, and an attribute feature corresponding to the attribute node.

After the object node and the neighbor node (including the foregoing interaction node and attribute node) are obtained, feature extraction is performed on the object node and the neighbor node, respectively, to obtain an object feature corresponding to the object node, an interaction feature corresponding to the interaction node, and an attribute feature corresponding to the attribute node.

In an actual application, the server may perform feature extraction on the object node and the neighbor node respectively at the same time, or may first perform feature extraction on the neighbor node and then perform feature extraction on the object node, or may first perform feature extraction on the object node and then perform feature extraction on the neighbor node. This is not limited in embodiments of this disclosure.

S204: Fuse the object feature, the interaction feature, and the attribute feature to obtain a sample node feature of the target object.

The server may directly add the object feature, the interaction feature, and the attribute feature, to implement fusion of the object feature, the interaction feature, and the attribute feature. Alternatively, the server may obtain a weight of the object feature, a weight of the interaction feature, and a weight of the attribute feature, and then perform weighted summation on the object feature, the interaction feature, and the attribute feature based on the respective weights. Alternatively, the object feature and the interaction feature may be fused to obtain a first fusion result, the object feature and the attribute feature are fused to obtain a second fusion result, and then the obtained first fusion result and the obtained second fusion result are added to obtain a sample node feature of the target object.

For example, the process of fusing the object feature, the interaction feature, and the attribute feature to obtain a sample node feature of the target object may be:
fusing the object feature and the interaction feature to obtain a first sample node feature of the target object;
fusing the object feature and the attribute feature to obtain a second sample node feature of the target object; and
determining a sample node feature of the target object according to the first sample node feature and the second sample node feature.

If there is a plurality of attribute nodes, each attribute feature is separately fused with the object feature to obtain a plurality of second sample node features.

In embodiments of this disclosure, an object feature and an interaction feature are fused to obtain a first node sample feature. The object feature and an attribute feature are fused to obtain a second sample node feature of a target object. Finally, a sample node feature of the target object is determined according to the first sample node feature and the second sample node feature, thereby improving accuracy of determining the sample node feature of the target object.

The process of determining a sample node feature of the target object according to the first sample node feature and the second sample node feature may be:
adding the first sample node feature and the second sample node feature to obtain a sample node feature of the target object.

Alternatively, the process of determining a sample node feature of the target object according to the first sample node feature and the second sample node feature may be:
obtaining a first weight corresponding to the first sample node feature and a second weight corresponding to the second sample node feature;
adjusting, according to the first weight, the first sample node feature to obtain an adjusted first sample node feature;
adjusting, according to the second weight, the second sample node feature to obtain an adjusted second sample node feature; and
determining a sample node feature of the target object according to the adjusted first sample node feature and the adjusted second sample node feature.

In embodiments of this disclosure, since importance of an interaction feature and an attribute feature for a target object may be different, a first weight of a first sample node feature and a second weight of a second sample node feature may be determined according to the importance. Then, the first sample node feature is adjusted according to the first weight of the first sample node feature to obtain an adjusted first sample node feature, and the second sample node feature is adjusted according to the second weight of the second sample node feature to obtain an adjusted second sample node feature. Finally, the adjusted first sample node feature and the adjusted second sample node feature are added to obtain a sample node feature of the target object, thereby improving accuracy of the sample node feature.

In an actual application, the importance of the interaction feature and the attribute feature for the target object may be set based on an actual situation. The importance may be in a positive correlation with the weight of the sample node feature. For example, if the importance of the interaction feature for the target object is a first importance and the importance of the attribute feature for the target object is a second importance, the first weight of the first sample node feature and the second weight of the second sample node feature may be determined based on a ratio of the first importance to the second importance, and a sum of the first weight and the second weight is 1.

If there is a plurality of second sample node features, second weights corresponding to the respective second sample node features may be the same or different. When a neighbor node is obtained by using preset meta-paths, each preset meta-path corresponds to one weight. To be specific, each sub-heterogeneous data structure corresponds to one weight. For example, when a first sample node feature x1 is obtained by using a preset meta-path p1, a second sample node feature x2 is obtained by using a preset meta-path p2, and a second sample node feature x3 is obtained by using a preset meta-path p3, a first weight corresponding to the first sample node feature x1, a second weight corresponding to the second sample node feature x2, and a second weight corresponding to the second sample node feature x3 are different.

In this case, the first sample node feature, the first weight, the second weight, and the second sample node feature may be substituted into the following formula (1) to obtain the sample node feature of the target object:

$$h = {\sum }_{q} {β}_{q} {h}_{q} \qquad ( 1 )$$

where h represents the sample node feature, β_{q} represents the first weight or the second weight, h_{q} represents the first sample node feature or the second sample node feature, and q represents a total quantity of categories of the interaction node and the attribute node.

In some embodiments, the process of obtaining a first weight corresponding to the first sample node feature and a second weight corresponding to the second sample node feature includes:
performing first fusion on the first sample node feature and the second sample node feature to obtain a fused node feature;
performing first mapping on the fused node feature to obtain a first mapped node feature; and
screening out a first weight corresponding to the first sample node feature and a second weight corresponding to the second sample node feature from the first mapped node feature.

In embodiments of this disclosure, a first weight of a first sample node feature may be determined in real time according to the first sample node feature, and a second weight of a second sample node feature may be determined in real time according to the second sample node feature, to improve accuracy of the first weight and the second weight, thereby improving accuracy of a sample node feature obtained according to the first weight and the second weight.

The first fusion may be concatenated fusion or additive fusion. When the first fusion is concatenated fusion, the first sample node feature and the second sample node feature may be substituted into the following formula (2) to perform first fusion and first mapping, to obtain a first mapped node feature:

$$β = ⌊ {h}_{1} ⊕ {h}_{2} ⊕ {h}_{3} … ⊕ {h}_{q} ⌋ \cdot W \qquad ( 2 )$$

where h_{q} represents the first sample node feature or the second sample node feature, ⊕ represents the concatenated fusion, W represents a first mapping function, and β represents the first mapped node feature.

In an actual application, after a first mapped node feature is obtained, the first mapped node feature may be normalized to obtain a normalized node feature. To be specific, the first mapped node feature is substituted into the following formula (3) for normalization to obtain the normalized node feature:

$${β}^{′} = soft max ( β ) \qquad ( 3 )$$

where β′ represents the normalized node feature, and softmax represents a normalization function.

In an actual application, after a normalized node feature is obtained, the first weight corresponding to the first sample node feature and the second weight corresponding to the second sample node feature are selected from the normalized node feature. For example, the server may determine a weight order corresponding to the first sample node feature and a weight order of the second sample node feature according to a fusion order of the first sample node feature and the second sample node feature in the first fusion, and then select, from the normalized node feature according to the weight order, the first weight corresponding to the first sample node feature and the second weight corresponding to the second sample node feature.

For example, q is 3, h1 represents the first sample node feature, and h2 and h3 represent the second sample node feature. According to the fusion order of Formula (2), a weight order of h1 is a first dimension, a weight order of h2 is a second dimension, and a weight order of h3 is a third dimension. A sub-feature of the first dimension in the normalized node feature is set as the first weight, a sub-feature of the second dimension in the normalized node feature is set as the second weight of h2, and a sub-feature of the second dimension in the normalized node feature is set as the second weight of h3.

In some embodiments, to extract a high-order feature corresponding to the object node, the neighbor node of the object node may include multi-order neighbor nodes. To be specific, the neighbor node not only includes an interaction node and an attribute node, but also includes another object node corresponding to another object in the objects. The another object is an object other than the target object and the interaction object in the objects. In this case, the operation of fusing the object feature, the interaction feature, and the attribute feature to obtain a sample node feature of the target object includes:
screening out a tail-order neighbor node of the object node from the multi-order neighbor nodes, and screening out a previous-order neighbor node to the tail-order neighbor node from the multi-order neighbor nodes;
fusing a node feature of the tail-order neighbor node and a node feature of the previous-order neighbor node to obtain a sample node feature of the previous-order neighbor node;
setting, if the previous-order neighbor node is not the first-order neighbor node, the sample node feature of the previous-order neighbor node as the node feature of the previous-order neighbor node, setting the previous-order neighbor node as the tail-order neighbor node, and returning to the operation of screening out a previous-order neighbor node to the tail-order neighbor node from the multi-order neighbor nodes;
setting the sample node feature of the previous-order neighbor node as the interaction feature or the attribute feature if the previous-order neighbor node is the first-order neighbor node; and
fusing the object feature, the interaction feature, and the attribute feature to obtain a sample node feature of the target object.

For example, as shown in 502 in FIG. 5, an object node “shoe a1” includes a first-order neighbor node and a second-order neighbor node. The first-order neighbor node includes user u1 and user u2, and the second-order neighbor node includes shoe a2, shoe a6, and shoe all. The second-order neighbor node is a tail-order neighbor node of the object node. To be specific, shoe a2, shoe a6, and shoe all are set as tail-order neighbor nodes. A previous-order neighbor node of the second-order neighbor node is the first-order neighbor node. To be specific, a previous-order neighbor node of the tail-order neighbor node “shoe a2” and the tail-order neighbor node “shoe a6” is user u1, and a previous-order neighbor node of the tail-order neighbor node “shoe all” is user u2.

A node feature of the tail-order neighbor node and a node feature of the previous-order neighbor node are fused to obtain a sample node feature of the previous-order neighbor node. To be specific, a node feature of shoe a2, a node feature of shoe a6, and a node feature of user u1 are fused to obtain a sample node feature of the previous-order neighbor node “user u1”. A node feature of shoe all and a node feature of user u2 are fused to obtain a sample node feature of the previous-order neighbor node “user u2”.

The previous-order neighbor nodes “user u1” and “user u2” are the first-order neighbor nodes. Therefore, the sample node feature of the previous-order neighbor node “user u1” is set as an interaction feature of user u1, and the sample node feature of the previous-order neighbor node “user u2” is set as an interaction feature of user u2.

Then, an object feature of shoe a1, the interaction feature of user u1, and the interaction feature of user u2 are added to realize fusion of the object feature of shoe a1, the interaction feature of user u1, and the interaction feature of user u2, to obtain the first sample node feature of the object node.

In this case, after feature extraction is performed on the interaction node and the attribute node, the node feature of the interaction node and the node feature of the attribute node are obtained. Then, after the node features are fused, the interaction feature of the interaction node and the attribute feature of the attribute node are obtained.

In an actual application, the terminal may screen out a tail-order neighbor node of the object node from the multi-order neighbor nodes and screen out a previous-order neighbor node to the tail-order neighbor node from the multi-order neighbor nodes, by traversing the neighbor nodes of the object node.

Alternatively, when the neighbor nodes of the object node are obtained by using the preset meta-path, a tail-order neighbor node of the object node may be screened out from the multi-order neighbor nodes and a previous-order neighbor node to the tail-order neighbor node may be screened out from the multi-order neighbor nodes by using the preset meta-path. In this case, the process of screening out a tail-order neighbor node of the object node from the multi-order neighbor nodes and screening out a previous-order neighbor node to the tail-order neighbor node from the multi-order neighbor nodes may be:
obtaining a preset meta-path, where the preset meta-path includes an adjacent node type; and
screening out a tail-order neighbor node of the object node from the multi-order neighbor nodes, and screening out a previous-order neighbor node to the tail-order neighbor node from the multi-order neighbor nodes, according to the adjacent node type.

The preset meta-path includes a direction. Therefore, an end node type may be screened out from the adjacent node type according to the direction. Then, a node corresponding to the end node type in the multi-order neighbor nodes is set as the tail-order neighbor node of the object node, and a node corresponding to a previous node type of the end node type in the preset meta-path is set as the previous-order neighbor node to the tail-order neighbor node.

For example, the preset meta-path is item→user→item (the arrows represent a direction), the direction is from left to right, an object node and neighbor nodes obtained are shoe a1→user u1→shoe a2, and adjacent node types are a user and items. Since the direction is from left to right, an end node type in the adjacent node types is an item, a tail-order neighbor node is shoe a2 corresponding to the end node type “item”, a previous node type of the end node type “item” in the preset meta-path is a user, and a node corresponding to the previous node type is user u1. To be specific, a previous-order neighbor node to the tail-order neighbor node is user u1.

When a sub-heterogeneous data structure is generated and an edge in the sub-heterogeneous data structure includes a direction, a tail-order neighbor node of the object node may be screened out from the multi-order neighbor nodes according to the sub-heterogeneous data structure, and a previous-order neighbor node to the tail-order neighbor node may be screened out from the multi-order neighbor nodes.

For example, as shown in 502 in FIG. 5, a direction of an edge in the sub-heterogeneous data structure is that the second-order neighbor node “shoe a2” and the second-order neighbor node “shoe a6” point to the first-order neighbor node “user u1”. Then, the second-order neighbor node “shoe a2” and the second-order neighbor node “shoe a6” may be screened out from the multi-order neighbor nodes as tail-order neighbor nodes of the object node “shoe a1”, and the first-order neighbor node “user u1” is set as the previous-order neighbor node to the tail-order neighbor node.

In some embodiments, a tail-order neighbor node of an object node is screened out from multi-order neighbor nodes by using a preset meta-path, and a previous-order neighbor node to the tail-order neighbor node is screened out from the multi-order neighbor nodes, so that the multi-order neighbor nodes do not need to be traversed, thereby improving a speed of obtaining the tail-order neighbor node and the previous-order neighbor node.

After obtaining a tail-order neighbor node and a previous-order neighbor node, the server may directly fuse a node feature of the tail-order neighbor node and a node feature of the previous-order neighbor node to obtain a sample node feature of the previous-order neighbor node. Alternatively, the terminal may fuse the node feature of the tail-order neighbor node and the node feature of the previous-order neighbor node according to importance between the tail-order neighbor node and the previous-order neighbor node, to obtain a sample node feature of the previous-order neighbor node. In this case, the operation of fusing a node feature of the tail-order neighbor node and a node feature of the previous-order neighbor node to obtain a sample node feature of the previous-order neighbor node includes:
obtaining a weight between the tail-order neighbor node and the previous-order neighbor node, where the weight represents importance of the tail-order neighbor node for the previous-order neighbor node; adjusting, according to the weight, the node feature of the tail-order neighbor node to obtain an adjusted node feature of the tail-order neighbor node; and fusing the adjusted node feature and the node feature of the previous-order neighbor node to obtain a sample node feature of the previous-order neighbor node.

In embodiments of this disclosure, a node feature of a tail-order neighbor node is adjusted according to a weight between the tail-order neighbor node and a previous-order neighbor node, to obtain an adjusted node feature of the tail-order neighbor node. Then, the adjusted node feature and a node feature of the previous-order neighbor node are fused to obtain a sample node feature of the previous-order neighbor node, so that the sample node feature includes importance of the tail-order neighbor node for the previous-order neighbor node, and a recommendation result may be more accurate when recommendation is performed by using a trained recommendation meta-model obtained by training according to the sample node feature.

In this case, the node feature of the tail-order neighbor node and the node feature of the previous-order neighbor node may be substituted into the following formula (4) for fusion to obtain the sample node feature of the previous-order neighbor node:

$${h}_{k}^{′} = σ ( {\sum }_{j ∈ {N}_{k}} {α}_{kj} {h}_{j} + {h}_{k} ) \qquad ( 4 )$$

where

$${h}_{k}^{′}$$

represents a sample node feature of a previous-order neighbor node k, σ( ) represents an activation mapping function, Nₖ represents a tail-order neighbor node set of the previous-order neighbor node k, αₖⱼ represents a weight between a tail-order neighbor node j and the previous-order neighbor node k, hⱼ represents a node feature of the tail-order neighbor node j, hₖ represents a node feature of the previous-order neighbor node k.

In the process of fusing the object feature, the interaction feature, and the attribute feature to obtain a sample node feature of the target object, a weight between the object feature and the interaction feature may be determined according to importance between the object node and each interaction node. Then, after each interaction feature is adjusted by using the weight between the object feature and the interaction feature, and the adjusted interaction feature and the object feature are further fused. A weight between the object feature and the attribute feature is determined according to importance between the object node and each attribute node. Then, after each attribute feature is adjusted by using the weight between the object feature and the attribute feature, the adjusted attribute feature and the object feature are further fused.

To be specific, the object feature and the interaction feature may be fused and the object feature and the attribute feature may be fused by using the formula (4). In this case, the object node may be understood as a previous-order neighbor node, and the interaction node and the attribute node may be understood as tail-order neighbor nodes.

In some other embodiments, the process of obtaining a weight between the tail-order neighbor node and the previous-order neighbor node includes:
determining a similarity between the previous-order neighbor node and the tail-order neighbor node according to the node feature of the tail-order neighbor node and the node feature of the previous-order neighbor node; and determining a weight between the tail-order neighbor node and the previous-order neighbor node according to the similarity.

The server may map the node feature of the tail-order neighbor node and the node feature of the previous-order neighbor node to the same feature space, concatenate and fuse the mapped tail-order node feature and the mapped previous-order node feature to obtain a concatenated node feature, map the concatenated node feature to a real number, so as to use the real number to represent a similarity between the previous-order neighbor node and the tail-order neighbor node, and finally set the similarity as a weight between the tail-order neighbor node and the previous-order neighbor node.

In an actual application, after obtaining a similarity, the terminal may normalize the similarity, and then set the normalized similarity as a weight between the tail-order neighbor node and the previous-order neighbor node. In this case, the node feature of the tail-order neighbor node and the node feature of the previous-order neighbor node may be substituted into the following formula (5) for calculation, to obtain the weight between the tail-order neighbor node and the previous-order neighbor node:

$${α}_{kj} = \frac{exp ( leaky Re LU ( {a}^{T} [ {W}_{1} {h}_{k} ‖ {W}_{1} {h}_{j} ] ) )}{{\sum }_{y ∈ {N}_{k}} exp ( Leaky Re LU ( {a}^{T} [ {W}_{1} {h}_{k} ‖ {W}_{1} {h}_{y} ] ) )} , ∀ j ∈ {N}_{k} \qquad ( 5 )$$

where αₖⱼ represents the weight between the tail-order neighbor node j and the previous-order neighbor node k, exp( ) represents an exponential operation, LeakyReLU( ) represents an activation function, a^{T} represents an operation of mapping a concatenated node feature to a real number, [∥] represents concatenated fusion processing, W₁ represents mapping the node features to the same feature space, and Nₖ represents the tail-order neighbor node set of the previous-order neighbor node k.

In embodiments of this disclosure, a similarity between a tail-order neighbor node and a previous-order neighbor node may be determined in real time by using a node feature of the tail-order neighbor node and a node feature of the previous-order neighbor node, so that importance of the tail-order neighbor node for the previous-order neighbor node determined in real time according to the similarity is more accurate, and a weight between the tail-order neighbor node and the previous-order neighbor node is more accurate.

In some embodiments, after the object feature, the interaction feature, and the attribute feature are fused to obtain the sample node feature of the target object, an interaction parameter in a to-be-trained recommendation meta-model may be corrected according to the sample node feature to obtain a candidate recommendation meta-model.

The interaction parameter may be referred to as a preference parameter of the interaction object for the target object, or may be referred to as a prior parameter.

Meta-learning is a technology that enables a model to have a capability of learning to learn and adjust parameters. The model having the capability of learning to learn and adjust parameters may be referred to as a meta-model. The recommendation meta-model in embodiments of this disclosure is a recommendation model having the capability of learning to learn and adjust parameters. The principle of the meta-learning may be shown in FIG. 6. A meta-model is trained by using a plurality of tasks. One task may include training samples of one type. Each task is divided into a support set and a query set. First, a model parameter φ⁰ in the meta-model is locally updated (which may be understood as being corrected) by using a sample of the support set in task m to obtain \hat{θ}^{m}. Then, a loss value of task m is calculated by using a sample of the query set in task m according to \hat{θ}^{m}, and the model parameter φ⁰ is globally updated according to a gradient of the loss value to \hat{θ}^{m}, to obtain a model parameter φ¹. Next, the model parameter φ¹ is locally updated and globally updated by using task n to obtain a model parameter φ² until the training is completed, so that model parameters in the meta-model are first modified for training the meta-model subsequently using a small number of samples.

Therefore, in embodiments of this disclosure, a meta-model is applied to a recommendation system. To be specific, a to-be-trained recommendation meta-model is trained by using a sample node feature to obtain a trained recommendation meta-model, so that even if interaction data of a new item or a new user is relatively small, recommendation may be performed by using the trained recommendation meta-model, thereby resolving a problem of cold start of an item or cold start of a user.

However, in the process of training the to-be-trained recommendation meta-model, if all objects in the recommendation system share the same interaction parameter, recommendation accuracy is relatively low and a recommendation result is relatively poor when recommendation is performed by using the trained recommendation meta-model. An object usually has some inherent attributes. Therefore, in embodiments of this disclosure, an object feature, an interaction feature, and an attribute feature are fused to obtain a sample node feature of a target object, so that the sample node feature includes the attribute feature. Then, an interaction parameter in a to-be-trained recommendation meta-model is corrected according to the sample node feature to obtain a candidate recommendation meta-model. The interaction parameter in the to-be-trained recommendation meta-model is corrected according to the attribute of the object, so that objects having similar attribute features have similar interaction parameters, thereby implementing feature adaptation. Therefore, when recommendation is performed by using a trained recommendation meta-model obtained by training the candidate recommendation meta-model according to the sample node feature, an item may be more accurately recommended to a user, thereby improving recommendation accuracy.

In an actual application, the terminal may directly perform second fusion on the sample node feature and the interaction parameter, to correct the interaction parameter in the to-be-trained recommendation meta-model to obtain the candidate recommendation meta-model. Alternatively, the terminal may perform second mapping on the sample node feature to obtain a second mapped node feature corresponding to the target object, and then perform second fusion on the interaction parameter and the second mapped node feature, to correct the interaction parameter in the to-be-trained recommendation meta-model to obtain the candidate recommendation meta-model.

The second mapped node feature may be understood as prior knowledge corresponding to the target object. The interaction parameter is corrected by using the prior knowledge of the target object.

In an actual application, the terminal may map the sample node feature to the second mapped node feature by using a fully-connected layer in the to-be-trained recommendation meta-model. To be specific, the sample node feature may be substituted into the following formula (6) to perform second mapping to obtain the second mapped node feature:

$${x}_{z} = δ ( {W}_{9} {h}_{z}^{′} + {b}_{g} ) \qquad ( 6 )$$

where x_{z} represents a second mapped node feature of a target object z, δ( ) represents the second mapping, W_{g} represents a matrix parameter of the fully-connected layer,

$${Φ}_{z} = Φ ∘ {x}_{z} \qquad ( 7 )$$

represents a sample node feature of the target object z, and b_{g} represents a bias parameter of the fully-connected layer.

After obtaining a second mapped node feature, the terminal then multiplies the second mapped node feature by the interaction parameter, to implement second fusion to obtain a candidate interaction parameter. The to-be-trained recommendation meta-model including the candidate interaction parameter is referred to as the candidate recommendation meta-model. To be specific, the second mapped node feature and the interaction parameter may be substituted into the following formula (7) to obtain the candidate interaction parameter:

$${h}_{z}^{′}$$

where Φ_{z} represents the candidate interaction parameter, Φ represents the interaction parameter, and ∘ represents element-by-element multiplication.

S205: Train, according to the sample node feature, a candidate recommendation meta-model to obtain a trained recommendation meta-model.

After obtaining a candidate recommendation meta-model, the server then performs interaction score prediction based on the interaction feature and the sample node feature to obtain a predicted interaction score of the interaction object for the target object, then obtains a real interaction score between the interaction object and the target object, determines a target loss value of the candidate recommendation meta-model according to the predicted interaction score and the real interaction score, and trains the candidate recommendation meta-model according to the target loss value to obtain a trained recommendation meta-model.

An interaction score prediction operation may include a fusion operation and a mapping operation. The interaction feature and the sample node feature may be substituted into the following formula (8) to perform fusion mapping:

$${r}_{uz}^{′} = sigmoid ( f ( u ⊕ {h}_{z}^{′} ) ) \qquad ( 8 )$$

where

$${r}_{uz}^{′}$$

represents a predicted interaction score of an interaction object u for the target object z, sigmoid( ) represents the activation function for mapping, ⊕ represents the concatenated fusion, and f( ) represents a multilayer perceptron.

In an actual application, the process of training, according to the target loss value, the candidate recommendation meta-model to obtain a trained recommendation meta-model may be:
updating, according to the target loss value, the interaction parameter in the candidate recommendation meta-model to obtain an updated recommendation meta-model; obtaining a sample node feature in a query set, and determining a first target loss value of the updated recommendation meta-model according to the sample node feature in the query set; setting, if the first target loss value satisfies a preset loss condition, the updated recommendation meta-model as a trained recommendation meta-model; and
globally updating, if the first target loss value does not satisfy the preset loss condition, model parameters of the to-be-trained recommendation meta-model according to the first target loss value, and returning to the operation of performing feature extraction on the object node, the interaction node, and the attribute node, respectively.

After an object node and neighbor nodes of the object node are obtained, the neighbor nodes of the object node may be divided to obtain a support set and a query set corresponding to the object node. Then, feature extraction is performed on nodes in the support set and the query set to obtain a sample node feature corresponding to the support set and a sample node feature corresponding to the query set.

The process of updating, according to the target loss value, the interaction parameter in the candidate recommendation meta-model to obtain an updated recommendation meta-model may be: solving a gradient of the target loss value for the interaction parameter, and updating the interaction parameter according to the gradient of the interaction parameter to obtain an updated recommended meta-model. To be specific, in this case, gradient descent update is performed by using a gradient ∇L(W₂∪Φ_{z}, S_{z}), Φ_{z} is updated to Φ′_{z}, and W₂ is not updated. W₂∪Φ_{z} represents all model parameters, W₂ represents a parameter for performing feature extraction and fusion processing on the object node and the neighbor node, and S_{z} represents a support set of the target object z.

The process of determining a first target loss value of the updated recommendation meta-model according to the sample node feature in the query set may be: performing fusion mapping on the interaction feature in the query set and the sample node feature in the query set to obtain a target predicted interaction score; obtaining a target real interaction score between the interaction object in the query set and the target object; and determining a first target loss value according to the target predicted interaction score and the target real interaction score. The mode of determining a first target loss value according to the target predicted interaction score and the target real interaction score may be selected according to an actual situation. For example, the first target loss value may be calculated by using a minimum square error function or a cross entropy loss function. This is not limited in embodiments of this disclosure.

When the first target loss value is calculated by using the minimum square error function, the first target loss value may be calculated by using the following formula (9):

$${L}^{′} = \frac{1}{\vert R \vert} {\sum }_{( u , z ) ∈ R} {( {r}_{uz} - {r}_{uz}^{″} )}^{2} \qquad ( 2 )$$

where L′ represents the first target loss value, R represents an interaction matrix between the target object z and the interaction object u, r_{uz} represents a target real interaction score between the target object z and the interaction object u, and

$${r}_{uz}^{″}$$

represents a target predicted interaction score between the target object z and the interaction object u.

When the first target loss value does not satisfy the preset loss condition, model parameters in the to-be-trained recommendation meta-model are globally updated according to the first target loss value. All the model parameters in the to-be-trained recommendation meta-model are updated. All the model parameters not only include the interaction parameter, but also include a parameter for performing feature extraction and fusion on the object node and the neighbor node, and the like. To be specific, in this case, Φ and W₂ are updated by using descent of a gradient ∇L′(W₂∪Φ′_{z}, Q_{z}), where Q_{z} represents a query set of the target object z.

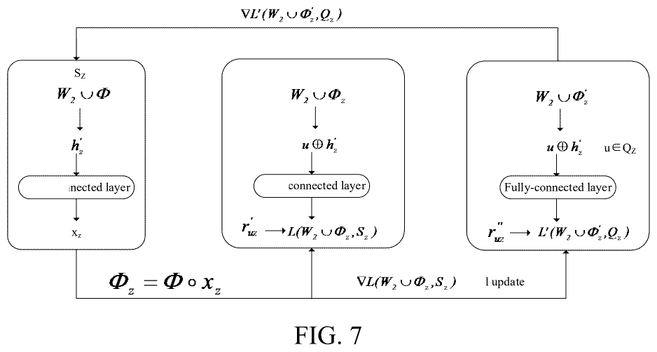

In embodiments of this disclosure, the interaction parameter in the to-be-trained recommendation meta-model is corrected by using the node sample feature in the support set to obtain the candidate recommendation meta-model. Then, the interaction parameter in the candidate recommendation meta-model is updated by using the node sample feature and the interaction feature in the support set to obtain the updated recommendation meta-model. Next, the updated recommendation meta-model is globally updated by using the sample node feature and the interaction feature in the query set, as shown in FIG. 7.

It can be learned from the foregoing that in embodiments of this disclosure, a heterogeneous data structure generated according to data in a recommendation system is obtained. The heterogeneous data structure includes a plurality of nodes. Each node corresponds to data, and the data includes an object and an attribute of the object. An object node corresponding to a target object in the objects and a neighbor node of the object node are screened out from the heterogeneous data structure. The neighbor node includes an interaction node corresponding to an interaction object that interacts with the target object and an attribute node corresponding to an attribute of the target object. Feature extraction is performed on the object node and the neighbor node, respectively, to obtain an object feature corresponding to the object node, an interaction feature corresponding to the interaction node, and an attribute feature corresponding to the attribute node. The object feature, the interaction feature, and the attribute feature are fused to obtain a sample node feature of the target object. An interaction parameter in a to-be-trained recommendation meta-model is corrected according to the sample node feature to obtain the candidate recommendation meta-model. A candidate recommendation meta-model is trained according to the sample node feature to obtain a trained recommendation meta-model.

A meta-model may rapidly and accurately learn a small amount of data. Therefore, in embodiments of this disclosure, even if interaction data of a new item or a new user in a recommendation system is relatively small, when recommendation is performed by using a trained recommendation meta-model obtained by training a to-be-trained recommendation meta-model according to the data in the recommendation system, the new item may be recommended to a user or an item may be recommended to the new user, thereby improving recommendation accuracy, and solving a cold start problem of the new item or the new user. Moreover, since a sample node feature of a target object includes an attribute feature of the target object, the interaction parameter in the to-be-trained recommendation meta-model is corrected by using the sample node feature of the target object to obtain a candidate recommendation meta-model, so that objects having similar attribute features have similar interaction parameters. Therefore, when recommendation is performed by using the trained recommendation meta-model obtained by training the candidate recommendation meta-model according to the sample node feature, the item may be more accurately recommended to the user, thereby improving recommendation accuracy.

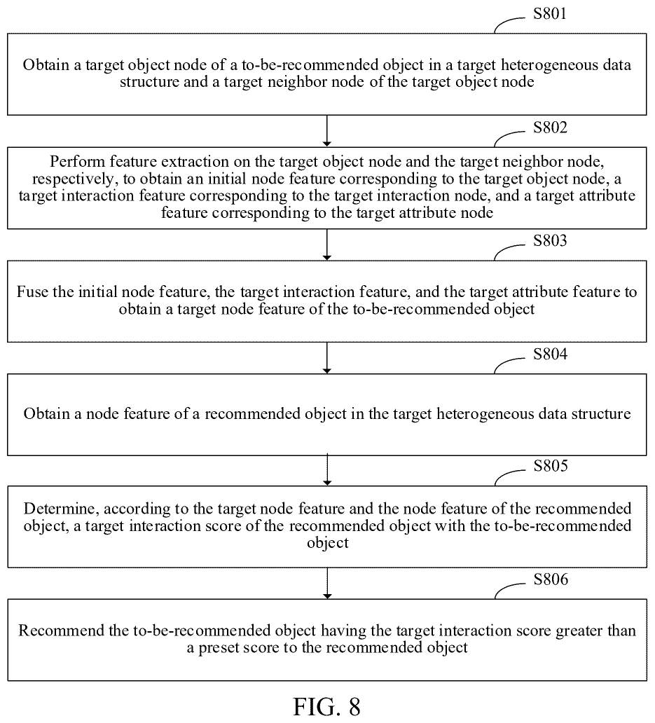

The following describes, with reference to FIG. 8, a method for recommending an object by using a trained recommendation meta-model. In an actual application, the object recommendation method may be independently implemented by a terminal or a server, or cooperatively implemented by a terminal and a server. The method is, for example, independently implemented by a server. The object recommendation method may include the following operations.

S801: Obtain a target object node of a to-be-recommended object in a target heterogeneous data structure and a target neighbor node of the target object node.

Herein, the target heterogeneous data structure includes a plurality of nodes. Each node corresponds to one object. The object may be a recommendation object or a recommended object. Data or object data corresponding to each node includes the object (object identifier) and an attribute of the object. The target object node is a node corresponding to a to-be-recommended object in the target heterogeneous data structure. The target neighbor node includes: a target interaction node corresponding to a target interaction object that interacts with the to-be-recommended object, and a target attribute node corresponding to an attribute of the to-be-recommended object. The to-be-recommended object may be an item in a recommendation system, and the recommended object is a user in the recommendation system. To be specific, in the recommendation system, the item is recommended to the user.

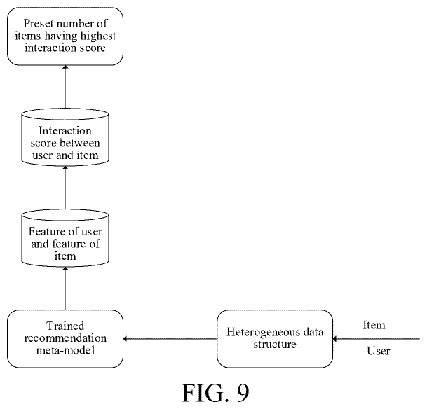

A trained recommendation meta-model (the trained recommendation meta-model may be referred to as a recall model) in embodiments of this disclosure is mainly used in a recall phase of the recommendation system. To be specific, a feature of the item and a feature of the user are obtained by using the trained recommendation meta-model. Then, an interaction score between the item and the user is determined according to the feature of the item and the feature of the user. Next, a preset number of items having the highest interaction score are recommended to the user, as shown in FIG. 9.

S802: Perform feature extraction on the target object node and the target neighbor node, respectively, to obtain an initial node feature corresponding to the target object node, a target interaction feature corresponding to the target interaction node, and a target attribute feature corresponding to the target attribute node.

In some embodiments, the recommendation meta-model includes a feature extraction layer. Correspondingly, feature extraction may be separately performed on the target object node and the target neighbor node by using the feature extraction layer of the recommendation meta-model, to obtain an initial node feature, a target interaction feature, and a target attribute feature.

S803: Fuse the initial node feature, the target interaction feature, and the target attribute feature to obtain a target node feature of the to-be-recommended object.

In some embodiments, the server may fuse the initial node feature, the target interaction feature, and the target attribute feature by: fusing the initial node feature and the target interaction feature to obtain a first target node feature, fusing the initial node feature and the target attribute feature to obtain a second target node feature, and then determining a target node feature of the to-be-recommended object according to the first target node feature and the second target node feature.

Herein, in an actual application, the target node feature of the to-be-recommended object may then be determined according to the first target node feature and the second target node feature by:
concatenating the first target node feature and the second target node feature to obtain the target node feature of the to-be-recommended object; or,
obtaining a weight of the first target node feature and a weight of the second target node feature respectively, and performing weighted fusion on the first target node feature and the second target node feature to obtain the target node feature of the to-be-recommended object.

In some embodiments, in addition to the feature extraction layer, the recommendation meta-model further includes a feature fusion layer. Correspondingly, operation S803 may be performed by the feature fusion layer of the recommendation meta-model.

S804: Obtain a node feature of a recommended object in the target heterogeneous data structure.

In an actual application, the process of obtaining the node feature of the recommended object by the server is similar to the process of obtaining the target node feature of the to-be-recommended object. For example, an object node of a recommended object in a target heterogeneous data structure and a neighbor node of the object node are obtained, and feature extraction is performed on the object node of the recommended object and the neighbor node of the object node by using a feature extraction layer of a recommendation meta-model, to obtain an initial node feature of the recommended object, an interaction feature of an interaction object that interacts with the recommended object, and an attribute feature of an attribute node corresponding to the recommended object. The initial node feature of the recommended object, the interaction feature of the interaction object that interacts with the recommended object, and the attribute feature of the attribute node corresponding to the recommended object are fused by using the feature fusion layer of the recommendation meta-model, to obtain a node feature of the recommended object.

S805: Determine, according to the target node feature and the node feature of the recommended object, a target interaction score of the recommended object with the to-be-recommended object.

In some embodiments, in addition to the feature extraction layer and the feature fusion layer, the recommendation meta-model further includes an interaction score prediction layer. Correspondingly, operation S805 may be performed by the interaction score prediction layer. To be specific, based on the target node feature and the node feature of the recommended object, interaction score prediction is performed by using the interaction score prediction layer, to obtain a target interaction score of the recommended object with the to-be-recommended object.

In an actual application, the interaction score prediction operation may include a fusion operation and a mapping operation. For example, the server first fuses the target node feature and the node feature of the recommended object, and then maps a target fused node feature obtained by fusion to obtain the target interaction score of the recommended object with the to-be-recommended object.

S806: Recommend the to-be-recommended object having the target interaction score greater than a preset score to the recommended object.

Herein, the preset score is a preset score threshold, and a value of the score threshold may be set according to an actual situation.

Operation S801 to operation S806 in embodiments of this disclosure may be all performed by the trained recommendation meta-model. Alternatively, operation S802 to operation S805 in embodiments of this disclosure may be performed by the trained recommendation meta-model, and operation S801 and operation S806 may not be performed by the trained recommendation meta-model.

In embodiments of this disclosure, a target object node of a to-be-recommended object in a heterogeneous data structure and a target neighbor node corresponding to the target object node are obtained. The target neighbor node includes a target interaction node corresponding to a target interaction object that interacts with the to-be-recommended object and a target attribute node corresponding to an attribute of the to-be-recommended object. Feature extraction is performed on the target object node and the target neighbor node to obtain an initial node feature corresponding to the target object node, a target interaction feature corresponding to the target interaction node, and a target attribute feature corresponding to the target attribute node. The initial node feature, the target interaction feature, and the target attribute feature are fused to obtain a target node feature of the to-be-recommended object. A node feature corresponding to a recommended object in the heterogeneous data structure is obtained. A target interaction score of the recommended object with the to-be-recommended object is determined according to the target node feature and the node feature corresponding to the recommended object. The to-be-recommended object having the target interaction score greater than a preset score is recommended to the recommended object, to implement object recommendation by using a trained recommendation meta-model, so that even if interaction data of a new item or a new user in the recommendation system is relatively small, the new item may be recommended to a user or an item may be recommended to the new user. Moreover, an interaction parameter in the trained recommendation meta-model is corrected according to an attribute feature of a target object. Therefore, an object is recommended by using the trained recommendation meta-model, so that the item may be more accurately recommended to the user, thereby improving recommendation accuracy.

According to the method described in the foregoing embodiments, the following provides detailed descriptions by using an example.

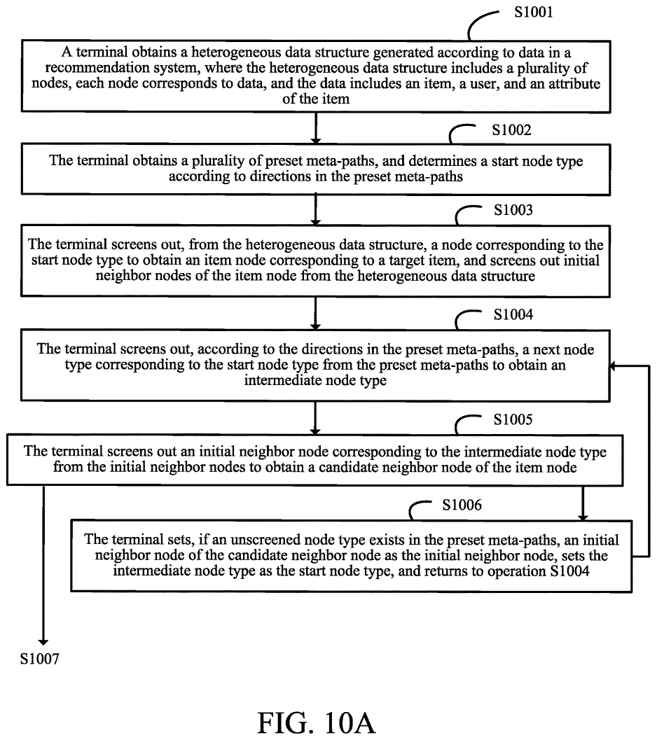

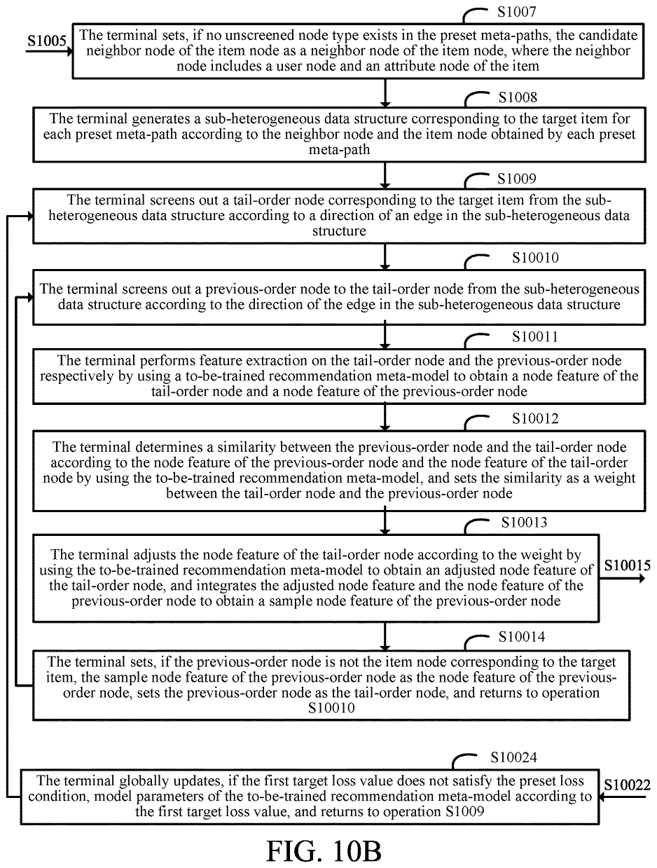

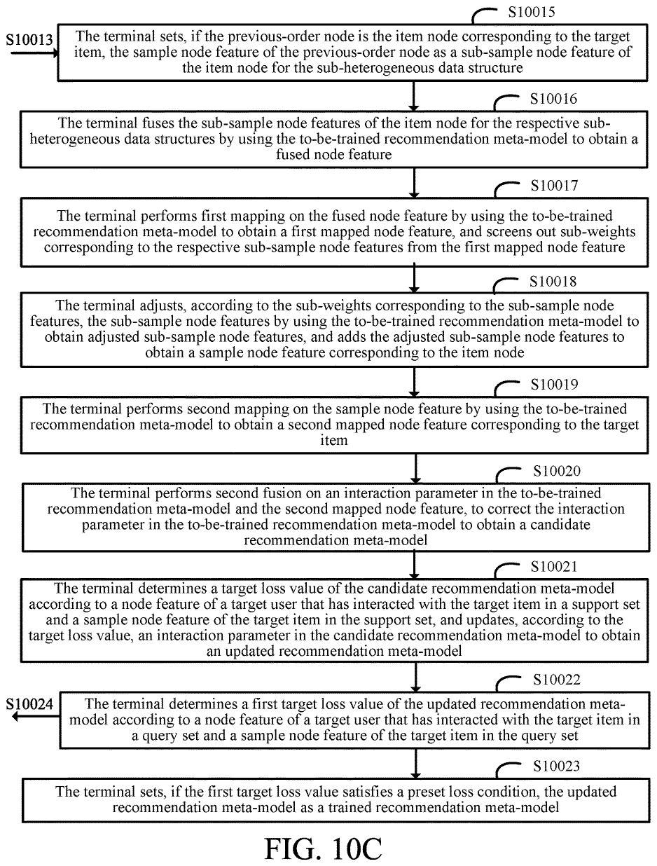

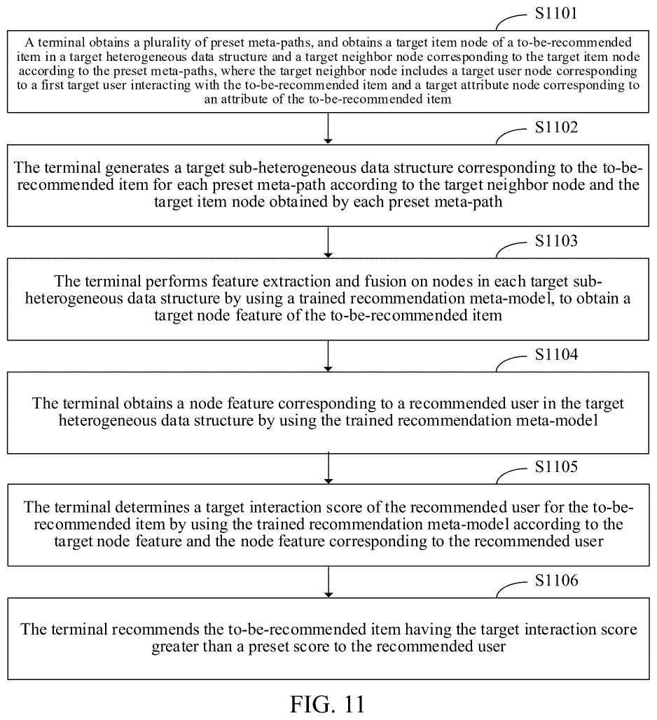

A model training method and a model application method provided in embodiments of this disclosure are described below with reference to FIGS. 10A-10C and FIG. 11. In this embodiment, item recommendation is performed based on an item. The item is set as a target object, and a user is set as an interaction object. To be specific, an item node is set as an object node, and a user node is set as an interaction node.

Referring to FIGS. 10A-10C, which include a schematic flowchart of a model training method according to an embodiment of this disclosure. In an actual application, the method may be independently implemented by a terminal or a server, or cooperatively implemented by a terminal and a server. The method is, for example, independently implemented by a terminal. The flow of the model training method may include the following operations.

S1001: The terminal obtains a heterogeneous data structure generated according to data in a recommendation system, where the heterogeneous data structure includes a plurality of nodes, each node corresponds to data, and the data includes an item, a user, and an attribute of the item.

S1002: The terminal obtains a plurality of preset meta-paths, and determines a start node type according to directions in the preset meta-paths.

S1003: The terminal screens out, from the heterogeneous data structure, a node corresponding to the start node type to obtain an item node corresponding to a target item, and screens out initial neighbor nodes of the item node from the heterogeneous data structure.

S1004: The terminal screens out, according to the directions in the preset meta-paths, a next node type corresponding to the start node type from the preset meta-paths to obtain an intermediate node type.

S1005: The terminal screens out an initial neighbor node corresponding to the intermediate node type from the initial neighbor nodes to obtain a candidate neighbor node of the item node.

S1006: The terminal sets, if an unscreened node type exists in the preset meta-paths, an initial neighbor node of the candidate neighbor node as the initial neighbor node, sets the intermediate node type as the start node type, and returns to operation S1004.

S1007: The terminal sets, if no unscreened node type exists in the preset meta-paths, the candidate neighbor node of the item node as a neighbor node of the item node, where the neighbor node includes a user node and an attribute node of the item.

S1008: The terminal generates a sub-heterogeneous data structure corresponding to the target item for each preset meta-path according to the neighbor node and the item node obtained by each preset meta-path.

The sub-heterogeneous data structures may be divided to obtain a sub-heterogeneous data structure of the target item in a support set and a sub-heterogeneous data structure of the target item in a query set.

Nodes in the sub-heterogeneous data structure correspond to an item and a user, or nodes in the sub-heterogeneous data structure correspond to an item and an attribute of the item. A direction of an edge in the sub-heterogeneous data structure is opposite to the direction in the preset meta-path.

The item corresponding to the node in the sub-heterogeneous data structure may be only the target item, or may include the target item and a first item. The first item is an item other than the target item in the recommendation system.

S1009: The terminal screens out a tail-order node corresponding to the target item from the sub-heterogeneous data structure according to a direction of an edge in the sub-heterogeneous data structure.

S10010: The terminal screens out a previous-order node to the tail-order node from the sub-heterogeneous data structure according to the direction of the edge in the sub-heterogeneous data structure.

In this embodiment, the sub-heterogeneous data structure of the target item includes the item node corresponding to the target item and the neighbor node corresponding to the item node. Therefore, screening out the previous-order node from the sub-heterogeneous data structure is not only screening out the previous-order node from the neighbor node of the item node, but also screening out the previous-order node from the item node. Therefore, in this embodiment, the previous-order node includes a previous-order neighbor node, and the tail-order node includes a tail-order neighbor node.

The tail-order node includes a user node corresponding to the user, an attribute node corresponding to an attribute of the target item, or a first item node corresponding to the first item. The previous-order node includes a user node corresponding to the user, an attribute node corresponding to an attribute of the target item, or an item node.

S10011: The terminal performs feature extraction on the tail-order node and the previous-order node respectively by using a to-be-trained recommendation meta-model to obtain a node feature of the tail-order node and a node feature of the previous-order node.

The node feature in embodiments of this disclosure is a feature obtained after feature extraction is directly performed on the node. If the tail-order node is a user node of a target user that has interacted with the target item, the node feature of the tail-order node may be referred to as an interaction feature of the target user. If the tail-order node is an attribute node of an attribute of the target item, the node feature of the tail-order node may be referred to as an attribute feature. In this case, the interaction feature and the attribute feature are features obtained after direct feature extraction.

S10012: The terminal determines a similarity between the previous-order node and the tail-order node according to the node feature of the previous-order node and the node feature of the tail-order node by using the to-be-trained recommendation meta-model, and sets the similarity as a weight between the tail-order node and the previous-order node.

The weight represents importance of the tail-order node for the previous-order node.

S10013: The terminal adjusts the node feature of the tail-order node according to the weight by using the to-be-trained recommendation meta-model to obtain an adjusted node feature of the tail-order node, and integrates the adjusted node feature and the node feature of the previous-order node to obtain a sample node feature of the previous-order node.

S10014: The terminal sets, if the previous-order node is not the item node corresponding to the target item, the sample node feature of the previous-order node as the node feature of the previous-order node, sets the previous-order node as the tail-order node, and returns to operation S10010.

If the previous-order node is a user node of a target user that has interacted with the target item, the sample node feature of the previous-order node may be referred to as an interaction feature of the target user. If the previous-order node is an attribute node of an attribute of the target item, the sample node feature of the previous-order node may be referred to as an attribute feature. In this case, the interaction feature and the attribute feature are fused features.

S10015: The terminal sets, if the previous-order node is the item node corresponding to the target item, the sample node feature of the previous-order node as a sub-sample node feature of the item node for the sub-heterogeneous data structure.

When the sub-heterogeneous data structure is a data structure including the user node, the sub-sample node feature of the sub-heterogeneous data structure may be referred to as a first sample node feature. When the sub-heterogeneous data structure is a data structure including the attribute node, the sub-sample node feature of the sub-heterogeneous data structure may be referred to as a second sample node feature.

S10016: The terminal fuses the sub-sample node features of the item node for the respective sub-heterogeneous data structures by using the to-be-trained recommendation meta-model to obtain a fused node feature.

S10017: The terminal performs first mapping on the fused node feature by using the to-be-trained recommendation meta-model to obtain a first mapped node feature, and screens out sub-weights corresponding to the respective sub-sample node features from the first mapped node feature.

When the sub-heterogeneous data structure is a data structure including the user node, the sub-weight of the sub-sample node feature of the sub-heterogeneous data structure may be referred to as a first weight. When the sub-heterogeneous data structure is a data structure including the attribute node, the sub-weight of the sub-sample node feature of the sub-heterogeneous data structure may be referred to as a second weight.

S10018: The terminal adjusts, according to the sub-weights corresponding to the sub-sample node features, the sub-sample node features by using the to-be-trained recommendation meta-model to obtain adjusted sub-sample node features, and adds the adjusted sub-sample node features to obtain a sample node feature corresponding to the item node.

S10019: The terminal performs second mapping on the sample node feature by using the to-be-trained recommendation meta-model to obtain a second mapped node feature corresponding to the target item.

S10020: The terminal performs second fusion on an interaction parameter in the to-be-trained recommendation meta-model and the second mapped node feature, to correct the interaction parameter in the to-be-trained recommendation meta-model to obtain a candidate recommendation meta-model.

S10021: The terminal determines a target loss value of the candidate recommendation meta-model according to a node feature of a target user that has interacted with the target item in a support set and a sample node feature of the target item in the support set, and updates, according to the target loss value, an interaction parameter in the candidate recommendation meta-model to obtain an updated recommendation meta-model.

S10022: The terminal determines a first target loss value of the updated recommendation meta-model according to a node feature of a target user that has interacted with the target item in a query set and a sample node feature of the target item in the query set.

S10023: The terminal sets, if the first target loss value satisfies a preset loss condition, the updated recommendation meta-model as a trained recommendation meta-model.

S10024: The terminal globally updates, if the first target loss value does not satisfy the preset loss condition, model parameters of the to-be-trained recommendation meta-model according to the first target loss value, and returns to operation S1009.

Referring to FIG. 11, FIG. 11 is a schematic flowchart of a model application method according to an embodiment of this disclosure. The flow of the model application method may include:

S1101: A terminal obtains a plurality of preset meta-paths, and obtains a target item node of a to-be-recommended item in a target heterogeneous data structure and a target neighbor node corresponding to the target item node according to the preset meta-paths, where the target neighbor node includes a target user node corresponding to a first target user interacting with the to-be-recommended item and a target attribute node corresponding to an attribute of the to-be-recommended item.

S1102: The terminal generates a target sub-heterogeneous data structure corresponding to the to-be-recommended item for each preset meta-path according to the target neighbor node and the target item node obtained by each preset meta-path.

An implementation process of operation S1102 may be similar to implementation processes of operation S1002 to operation S1008. Details are not described in embodiments of this disclosure herein again.

S1103: The terminal performs feature extraction and fusion on nodes in each target sub-heterogeneous data structure by using a trained recommendation meta-model, to obtain a target node feature of the to-be-recommended item.

An implementation process of operation S1103 may be similar to implementation processes of operation S1009 to operation S10018.

S1104: The terminal obtains a node feature corresponding to a recommended user in the target heterogeneous data structure by using the trained recommendation meta-model.

S1105: The terminal determines a target interaction score of the recommended user for the to-be-recommended item by using the trained recommendation meta-model according to the target node feature and the node feature corresponding to the recommended user.

S1106: The terminal recommends the to-be-recommended item having the target interaction score greater than a preset score to the recommended user.

The following describes a recommendation effect of the trained recommendation meta-model by using a livestreaming room as an item. The effect of recommending the livestreaming room by using the trained recommendation meta-model may be shown in the following table (pv represents a page view, and Pctr represents a page view click-through rate):

| | Click/ | View | View | | | Viewing |
|---|---|---|---|---|---|---|
| | tap pv | pv | pv60 | Pctr60 | Pctr | duration |
| Increased | +1.298% | +1.452% | +0.313% | +1.215% | +0.217% | +0.991% |
| amplitude | | | | | | |

It may be learned from the foregoing table that a recommendation effect after the trained recommendation meta-model in embodiments of this disclosure is applied is improved.

To better implement the model training method provided in embodiments of this disclosure, embodiments of this disclosure further provide an apparatus based on the foregoing model training method. Nouns have meanings the same as that in the foregoing model training method, and implementation details may be similar to the descriptions in the method embodiments.

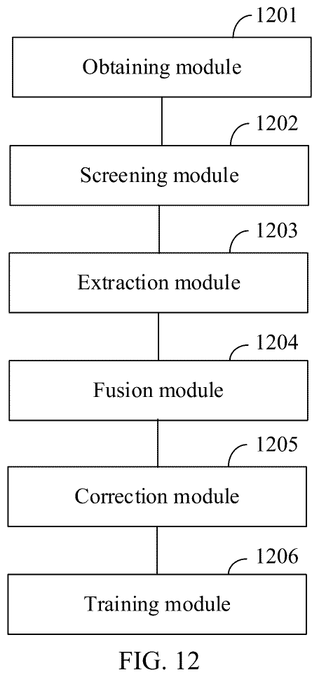

For example, as shown in FIG. 12, the model training apparatus may include:
an obtaining module 1201, configured to obtain a heterogeneous data structure including a plurality of nodes, where data corresponding to each node includes an object and an attribute of the object;
a screening module 1202, configured to obtain, from the heterogeneous data structure, an object node corresponding to a target object, an interaction node corresponding to an interaction object that interacts with the target object, and an attribute node corresponding to an attribute of the target object;
an extraction module 1203, configured to perform feature extraction on the object node, the interaction node, and the attribute node, respectively, to obtain an object feature corresponding to the object node, an interaction feature corresponding to the interaction node, and an attribute feature corresponding to the attribute node;
a fusion module 1204, configured to fuse the object feature, the interaction feature, and the attribute feature to obtain a sample node feature of the target object; and
a training module 1205, configured to train, according to the sample node feature, a candidate recommendation meta-model to obtain a trained recommendation meta-model.

In some embodiments, the apparatus further includes a correction module, configured to correct, according to the sample node feature, an interaction parameter in a to-be-trained recommendation meta-model to obtain the candidate recommendation meta-model.

In some embodiments, the screening module 1202 is further configured to:
obtaining a plurality of preset meta-paths, where the preset meta-paths include different node types; and
screening out an object node corresponding to a target object in the objects and a neighbor node of the object node from the heterogeneous data structure according to the different node types, where the neighbor node includes the interaction node and the attribute node.

In some embodiments, the different node types include a start node type and an adjacent node type. Correspondingly, the screening module 1202 is further configured to:
screen out a node corresponding to the start node type from the heterogeneous data structure to obtain an object node corresponding to the target object;
obtain initial neighbor nodes corresponding to the object node; and
screen out an initial neighbor node corresponding to the adjacent node type from the initial neighbor nodes as a neighbor node of the object node.

In some embodiments, the neighbor node includes multi-order neighbor nodes, and the interaction node and the attribute node are first-order neighbor nodes of the object node.

Correspondingly, the fusion module 1204 is further configured to:
screen out a tail-order neighbor node of the object node from the multi-order neighbor nodes, and screen out a previous-order neighbor node to the tail-order neighbor node from the multi-order neighbor nodes;
fuse a node feature of the tail-order neighbor node and a node feature of the previous-order neighbor node to obtain a sample node feature of the previous-order neighbor node;
set, if the previous-order neighbor node is not the first-order neighbor node, the sample node feature of the previous-order neighbor node as the node feature of the previous-order neighbor node, set the previous-order neighbor node as the tail-order neighbor node, and return to the operation of screening out a previous-order neighbor node to the tail-order neighbor node from the multi-order neighbor nodes;
set the sample node feature of the previous-order neighbor node as the interaction feature or the attribute feature if the previous-order neighbor node is the first-order neighbor node; and
fuse the object feature, the interaction feature, and the attribute feature to obtain a sample node feature of the target object.

In some embodiments, the fusion module 1204 is further configured to:
obtain a preset meta-path, where the preset meta-path includes an adjacent node type; and
screen out a tail-order neighbor node of the object node from the multi-order neighbor nodes, and screen out a previous-order neighbor node to the tail-order neighbor node from the multi-order neighbor nodes, according to the adjacent node type.

In some embodiments, the fusion module 1204 is further configured to:
obtain a weight between the tail-order neighbor node and the previous-order neighbor node, where the weight represents importance of the tail-order neighbor node for the previous-order neighbor node;
adjust, according to the weight, the node feature of the tail-order neighbor node to obtain an adjusted node feature of the tail-order neighbor node; and
fuse the adjusted node feature and the node feature of the previous-order neighbor node to obtain a sample node feature of the previous-order neighbor node.

In some embodiments, the fusion module 1204 is further configured to:
determine a similarity between the previous-order neighbor node and the tail-order neighbor node according to the node feature of the tail-order neighbor node and the node feature of the previous-order neighbor node; and
determine a weight between the tail-order neighbor node and the previous-order neighbor node according to the similarity.

In some embodiments, the fusion module 1204 is further configured to:
fuse the object feature and the interaction feature to obtain a first sample node feature of the target object;
fuse the object feature and the attribute feature to obtain a second sample node feature of the target object; and
determine a sample node feature of the target object according to the first sample node feature and the second sample node feature.

In some embodiments, the fusion module 1204 is further configured to:
obtain a first weight corresponding to the first sample node feature and a second weight corresponding to the second sample node feature;
adjust, according to the first weight, the first sample node feature to obtain an adjusted first sample node feature;
adjust, according to the second weight, the second sample node feature to obtain an adjusted second sample node feature; and
determine a sample node feature of the target object according to the adjusted first sample node feature and the adjusted second sample node feature.

In some embodiments, the fusion module 1204 is further configured to:
perform first fusion on the first sample node feature and the second sample node feature to obtain a fused node feature;
perform first mapping on the fused node feature to obtain a first mapped node feature; and
screen out a first weight corresponding to the first sample node feature and a second weight corresponding to the second sample node feature from the first mapped node feature.

In some embodiments, the correction module 1206 is further configured to:
perform second mapping on the sample node feature to obtain a second mapped node feature corresponding to the target object; and
perform second fusion on the interaction parameter and the second mapped node feature, to correct the interaction parameter in the to-be-trained recommendation meta-model to obtain the candidate recommendation meta-model.

In some embodiments, the training module 1205 is further configured to:
fuse and map the interaction feature and the sample node feature to obtain a predicted interaction score of the interaction object with the target object;
obtain a real interaction score between the interaction object and the target object;
determine a target loss value of the candidate recommendation meta-model according to the predicted interaction score and the real interaction score; and
train, according to the target loss value, the candidate recommendation meta-model to obtain a trained recommendation meta-model.

In an actual application, the sample node feature includes sample node features of an adjacent node group in a support set. Correspondingly, the training module 1205 is further configured to:
update, according to the target loss value, the interaction parameter in the candidate recommendation meta-model to obtain an updated recommendation meta-model;
obtain a sample node feature in a query set, and determine a first target loss value of the updated recommendation meta-model according to the sample node feature in the query set;
set, if the first target loss value satisfies a preset loss condition, the updated recommendation meta-model as a trained recommendation meta-model; and
globally update, if the first target loss value does not satisfy the preset loss condition, model parameters of the to-be-trained recommendation meta-model according to the first target loss value, and return to the operation of performing feature extraction on the object node and the neighbor node, respectively.

During specific implementation, the foregoing modules may be implemented as independent entities or may be combined in any mode as the same entity or several entities for implementation. Implementations of the foregoing modules and corresponding beneficial effects may be similar to those in the foregoing method embodiments. Details are not described herein again.

To better implement the object recommendation method provided in embodiments of this disclosure, embodiments of this disclosure further provide an apparatus based on the foregoing object recommendation method. Nouns have meanings the same as that in the foregoing object recommendation method, and implementation details may be similar to the descriptions in the method embodiments.

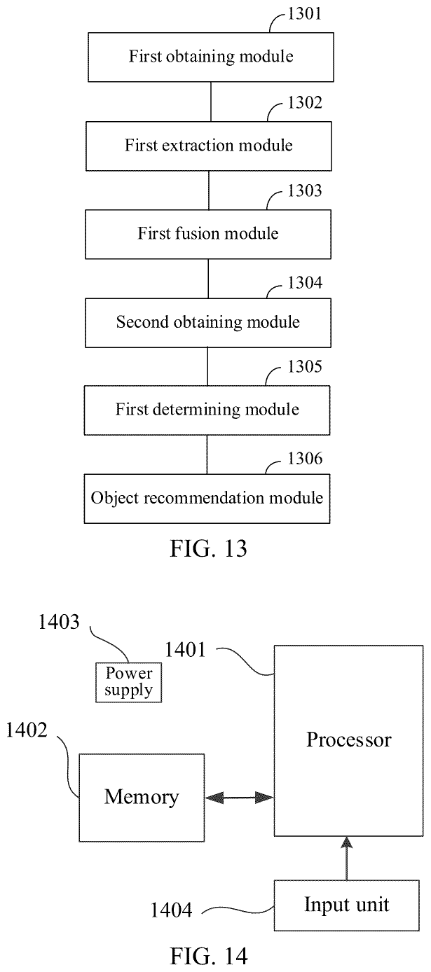

For example, as shown in FIG. 13, the object recommendation apparatus may include:
a first obtaining module 1301, configured to obtain a target object node of a to-be-recommended object in a target heterogeneous data structure and a target neighbor node corresponding to the target object node, where the target neighbor node includes a target interaction node corresponding to a target interaction object that interacts with the to-be-recommended object and a target attribute node corresponding to an attribute of the to-be-recommended object;
a first extraction module 1302, configured to perform feature extraction on the target object node and the target neighbor node to obtain an initial node feature corresponding to the target object node, a target interaction feature corresponding to the target interaction node, and a target attribute feature corresponding to the target attribute node;
a first fusion module 1303, configured to fuse the initial node feature, the target interaction feature, and the target attribute feature to obtain a target node feature of the to-be-recommended object;
a second obtaining module 1304, configured to obtain a node feature of a node corresponding to a recommended object in the target heterogeneous data structure;
a first determining module 1305, configured to determine, according to the target node feature and the node feature corresponding to the recommended object, a target interaction score of the recommended object with the to-be-recommended object; and
an object recommendation module 1306, configured to recommend the to-be-recommended object having the target interaction score greater than a preset score to the recommended object.

During specific implementation, the foregoing modules may be implemented as independent entities or may be combined in any mode as the same entity or several entities for implementation. Implementations of the foregoing modules and corresponding beneficial effects may be similar to those in the foregoing method embodiments. Details are not described herein again.

Embodiments of this disclosure further provide an electronic device. The electronic device may be a server, a terminal, or the like. FIG. 14 shows a schematic structural diagram of an electronic device involved in an embodiment of this disclosure.

The electronic device may include components such as a processor 1401 of one or more processing cores, a memory 1402 of one or more computer-readable storage media, a power supply 1403, and an input unit 1404. The electronic device structure shown in FIG. 14 does not constitute a limitation to the electronic device. The server may include more or fewer parts than those shown in the figure, may combine some parts, or may have different part arrangements.

The processor 1401 is a control center of the electronic device, which is connected to various parts of the entire electronic device by using various interfaces and lines, and by running or executing a computer program and/or module stored in the memory 1402 and calling data stored in the memory 1402, implements various functions of the electronic device and processes data. For example, the processor 1401 may include one or more processing cores. An application processor and a modem processor may be integrated into the processor 1401. The application processor mainly processes an operating system, a user interface, an application, and the like, and the modem processor mainly processes wireless communication. The foregoing modem may either not be integrated into the processor 1401.

The memory 1402 may be configured to store a computer program and a module. The processor 1401 runs the computer program and module stored in the memory 1402, to execute various functional applications and data processing. The memory 1402 may mainly include a program storage area and a data storage area. The program storage area may store an operating system, a computer program required by at least one function (for example, a sound playing function and an image playing function), or the like. The storage data area may store data or the like created according to the use of the electronic device. Furthermore, the memory 1402 may include a high speed random access memory, and may further include a non-volatile memory, such as at least one disk storage device, a flash memory, or another volatile solid-state storage device. Correspondingly, the memory 1402 may further include a memory controller, to provide access of the processor 1401 to the memory 1402.

The electronic device further includes the power supply 1403 for supplying power to the components. For example, the power supply 1403 may be logically connected to the processor 1401 by using a power management system, thereby implementing functions such as charging, discharging, and power consumption management by using the power management system. The power supply 1403 may further include one or more of a direct current or alternating current power supply, a re-charging system, a power failure detection circuit, a power supply converter or inverter, a power supply state indicator, and any other components.

The electronic device may further include an input unit 1404. The input unit 1404 may be configured to receive entered numeric or character information and generate keyboard, mouse, joystick, optical, or trackball signal input related to user settings and function control.

Although not shown in the figure, the electronic device may further include a display unit, and the like. Details are not described herein again. In some embodiments, the processor 1401 in the electronic device may load, according to the following instructions, executable files corresponding to processes of one or more computer programs into the memory 1402. The processor 1401 runs the computer programs stored in the memory 1402, to implement various functions, for example:
obtaining a heterogeneous data structure including a plurality of nodes, where data corresponding to each of the nodes includes an object and an attribute of the object;
obtaining, from the heterogeneous data structure, an object node corresponding to a target object in the objects, an interaction node corresponding to an interaction object that interacts with the target object, and an attribute node corresponding to an attribute of the target object;
performing feature extraction on the object node, the interaction node, and the attribute node, respectively, to obtain an object feature corresponding to the object node, an interaction feature corresponding to the interaction node, and an attribute feature corresponding to the attribute node;
fusing the object feature, the interaction feature, and the attribute feature to obtain a sample node feature of the target object; and
training, according to the sample node feature, a candidate recommendation meta-model to obtain a trained recommendation meta-model.

All or some operations of the methods in the foregoing embodiments may be implemented by using a computer program, or implemented through computer program controlling relevant hardware, and the computer program may be stored in a computer-readable storage medium and loaded and executed by a processor.

In view of this, embodiments of this disclosure provide a computer-readable storage medium, having a computer program stored therein. The computer program is suitable to be loaded by a processor, to implement the operations in any model training method or object recommendation method according to embodiments of this disclosure.

The computer-readable storage medium may include: a read-only memory (ROM), a random access memory (RAM), a magnetic disk, an optical disc, or the like.

Since the computer program stored in the computer-readable storage medium may perform the operations in any model training method or object recommendation method according to embodiments of this disclosure, advantageous effects that can be implemented by any model training method or object recommendation method according to embodiments of this disclosure may be implemented. The foregoing embodiments may be referred to for details. Details are not described herein again.

Embodiments of this disclosure further provide a computer program product or computer program. The computer program product or computer program includes computer instructions. The computer instructions are stored in a computer-readable storage medium. A processor of the computer device reads the computer instructions from the computer-readable storage medium, and the processor executes the computer instructions, to cause the computer device to perform the foregoing model training method or object recommendation method.

The model training method and apparatus, the electronic device, the computer-readable storage medium, and the computer program product provided in embodiments of this disclosure are described in detail above. The principles and implementation of this disclosure are described by applying specific examples, and the descriptions of the foregoing embodiments are only helpful to understand the method and core idea of this disclosure. Also, for a person skilled in the art, there will be changes in the implementation and the application scope according to the idea of this disclosure. By reason of the foregoing, the content of this specification cannot be construed as a limitation to this disclosure.

What is claimed is:

1. A model training method, comprising:
obtaining a heterogeneous data structure that includes a plurality of nodes, data corresponding to each of the nodes including an object and an attribute of the object;
obtaining, from the plurality of nodes of the heterogeneous data structure, an object node corresponding to a target object, an interaction node corresponding to an interaction object that interacts with the target object, and an attribute node corresponding to an attribute of the target object;
obtaining an object feature that is extracted from the object node, an interaction feature that is extracted from the interaction node, and an attribute feature that is extracted from the attribute node;
fusing the object feature, the interaction feature, and the attribute feature to obtain a sample node feature of the target object; and
training, according to the sample node feature, a candidate recommendation meta-model to obtain a trained recommendation meta-model.

2. The model training method according to claim 1, wherein the obtaining, from the plurality of nodes of the heterogeneous data structure, comprises:
obtaining a plurality of preset meta-paths, the preset meta-paths including different node types; and
screening out the object node corresponding to the target object in the objects and a neighbor node of the object node from the heterogeneous data structure according to the different node types, the neighbor node including the interaction node and the attribute node.

3. The model training method according to claim 2, wherein
the different node types include a start node type and an adjacent node type; and
the screening out comprises:
screening out a node corresponding to the start node type from the heterogeneous data structure as the object node corresponding to the target object;
obtaining initial neighbor nodes corresponding to the object node; and
screening out an initial neighbor node corresponding to the adjacent node type from the initial neighbor nodes as the neighbor node of the object node.

4. The model training method according to claim 1, wherein
the interaction node and the attribute node belong to a neighbor node of the object node, the neighbor node includes multi-order neighbor nodes, and the interaction node and the attribute node are first-order neighbor nodes of the object node; and
the fusing comprises:
screening out a tail-order neighbor node of the object node and a previous-order neighbor node to the tail-order neighbor node from the multi-order neighbor nodes;
fusing a node feature of the tail-order neighbor node and a node feature of the previous-order neighbor node to obtain a sample node feature of the previous-order neighbor node;
setting, when the previous-order neighbor node is not the first-order neighbor node, the sample node feature of the previous-order neighbor node as the node feature of the previous-order neighbor node, setting the previous-order neighbor node as the tail-order neighbor node, and screening out a previous-order neighbor node to the tail-order neighbor node from the multi-order neighbor nodes; and
setting the sample node feature of the previous-order neighbor node as the interaction feature or the attribute feature when the previous-order neighbor node is the first-order neighbor node.

5. The model training method according to claim 4, wherein the screening out the tail-order neighbor node of the object node and the previous-order neighbor node to the tail-order neighbor node comprises:
obtaining a preset meta-path, the preset meta-path including an adjacent node type; and
screening out the tail-order neighbor node of the object node and the previous-order neighbor node to the tail-order neighbor node from the multi-order neighbor nodes according to the adjacent node type.

6. The model training method according to claim 4, wherein the fusing the node feature of the tail-order neighbor node and the node feature of the previous-order neighbor node comprises:
obtaining a weight of the tail-order neighbor node, the weight representing importance of the tail-order neighbor node for the previous-order neighbor node;
adjusting, according to the weight, the node feature of the tail-order neighbor node to obtain an adjusted node feature of the tail-order neighbor node; and
fusing the adjusted node feature and the node feature of the previous-order neighbor node to obtain the sample node feature of the previous-order neighbor node.

7. The model training method according to claim 6, wherein the obtaining the weight of the tail-order neighbor node comprises:
determining a similarity between the previous-order neighbor node and the tail-order neighbor node according to the node feature of the tail-order neighbor node and the node feature of the previous-order neighbor node; and
determining the weight of the tail-order neighbor node according to the similarity.

8. The model training method according to claim 1, wherein the fusing comprises:
fusing the object feature and the interaction feature to obtain a first sample node feature of the target object;
fusing the object feature and the attribute feature to obtain a second sample node feature of the target object; and
determining the sample node feature of the target object according to the first sample node feature and the second sample node feature.

9. The model training method according to claim 8, wherein the determining the sample node feature of the target object according to the first sample node feature and the second sample node feature comprises:
obtaining a first weight of the first sample node feature and a second weight of the second sample node feature;
adjusting, according to the first weight, the first sample node feature to obtain an adjusted first sample node feature;
adjusting, according to the second weight, the second sample node feature to obtain an adjusted second sample node feature; and
determining the sample node feature of the target object according to the adjusted first sample node feature and the adjusted second sample node feature.

10. The model training method according to claim 9, wherein the obtaining the first weight of the first sample node feature and the second weight of the second sample node feature comprises:
performing first fusion on the first sample node feature and the second sample node feature to obtain a fused node feature;
performing first mapping on the fused node feature to obtain a first mapped node feature; and
screening out the first weight of the first sample node feature and the second weight of the second sample node feature from the first mapped node feature.

11. The model training method according to claim 1, further comprising:
correcting, according to the sample node feature, an interaction parameter in a to-be-trained recommendation meta-model to obtain the candidate recommendation meta-model.

12. The model training method according to claim 11, wherein the correcting comprises:
performing second mapping on the sample node feature to obtain a second mapped node feature corresponding to the target object; and
performing second fusion on the interaction parameter and the second mapped node feature, to correct the interaction parameter in the to-be-trained recommendation meta-model to obtain the candidate recommendation meta-model.

13. The model training method according to claim 12, wherein the training comprises:
performing interaction score prediction based on the interaction feature and the sample node feature to obtain a predicted interaction score of the interaction object with the target object;
obtaining a real interaction score between the interaction object and the target object;
determining a target loss value of the candidate recommendation meta-model according to the predicted interaction score and the real interaction score; and
training, according to the target loss value, the candidate recommendation meta-model to obtain the trained recommendation meta-model.

14. The model training method according to claim 13, wherein
the sample node feature includes sample node features of an adjacent node group in a support set; and
the training, according to the target loss value, the candidate recommendation meta-model to obtain a trained recommendation meta-model comprises:
updating, according to the target loss value, the interaction parameter in the candidate recommendation meta-model to obtain an updated recommendation meta-model;
obtaining a sample node feature in a query set, and determining a first target loss value of the updated recommendation meta-model according to the sample node feature in the query set;
setting, when the first target loss value satisfies a preset loss condition, the updated recommendation meta-model as a trained recommendation meta-model; and
globally updating, when the first target loss value does not satisfy the preset loss condition, model parameters of the to-be-trained recommendation meta-model according to the first target loss value, and performing feature extraction on the object node, the interaction node, and the attribute node, respectively.

15. An object recommendation method, comprising:
obtaining a target object node of a to-be-recommended object in a target heterogeneous data structure, a target interaction node corresponding to a target interaction object that interacts with the to-be-recommended object, and a target attribute node corresponding to an attribute of the to-be-recommended object;
obtaining an initial node feature that is extracted from the target object node, a target interaction feature that is extracted from the target interaction node, and a target attribute feature that is extracted from the target attribute node;
fusing the initial node feature, the target interaction feature, and the target attribute feature to obtain a target node feature of the to-be-recommended object;
obtaining a node feature of a node corresponding to a recommended object in the target heterogeneous data structure;
determining, according to the target node feature and the node feature of the recommended object, a target interaction score of the recommended object with the to-be-recommended object; and
recommending the to-be-recommended object having the target interaction score greater than a preset score to the recommended object.

16. A non-transitory computer-readable storage medium, storing instructions which when executed by a processor cause the processor to perform:
obtaining a heterogeneous data structure that includes a plurality of nodes, data corresponding to each of the nodes including an object and an attribute of the object;
obtaining, from the plurality of nodes of the heterogeneous data structure, an object node corresponding to a target object, an interaction node corresponding to an interaction object that interacts with the target object, and an attribute node corresponding to an attribute of the target object;
obtaining an object feature that is extracted from the object node, an interaction feature that is extracted from the interaction node, and an attribute feature that is extracted from the attribute node;
fusing the object feature, the interaction feature, and the attribute feature to obtain a sample node feature of the target object; and
training, according to the sample node feature, a candidate recommendation meta-model to obtain a trained recommendation meta-model.

17. The non-transitory computer-readable storage medium according to claim 16, wherein the obtaining, from the plurality of nodes of the heterogeneous data structure, comprises:
obtaining a plurality of preset meta-paths, the preset meta-paths including different node types; and
screening out the object node corresponding to the target object in the objects and a neighbor node of the object node from the heterogeneous data structure according to the different node types, the neighbor node including the interaction node and the attribute node.

18. The non-transitory computer-readable storage medium according to claim 17, wherein
the different node types include a start node type and an adjacent node type; and
the screening out comprises:
screening out a node corresponding to the start node type from the heterogeneous data structure as the object node corresponding to the target object;
obtaining initial neighbor nodes corresponding to the object node; and
screening out an initial neighbor node corresponding to the adjacent node type from the initial neighbor nodes as the neighbor node of the object node.

19. The non-transitory computer-readable storage medium according to claim 16, wherein
the interaction node and the attribute node belong to a neighbor node of the object node, the neighbor node includes multi-order neighbor nodes, and the interaction node and the attribute node are first-order neighbor nodes of the object node; and
the fusing comprises:
screening out a tail-order neighbor node of the object node and a previous-order neighbor node to the tail-order neighbor node from the multi-order neighbor nodes;
fusing a node feature of the tail-order neighbor node and a node feature of the previous-order neighbor node to obtain a sample node feature of the previous-order neighbor node;
setting, when the previous-order neighbor node is not the first-order neighbor node, the sample node feature of the previous-order neighbor node as the node feature of the previous-order neighbor node, setting the previous-order neighbor node as the tail-order neighbor node, and screening out a previous-order neighbor node to the tail-order neighbor node from the multi-order neighbor nodes; and
setting the sample node feature of the previous-order neighbor node as the interaction feature or the attribute feature when the previous-order neighbor node is the first-order neighbor node.

20. The non-transitory computer-readable storage medium according to claim 19, wherein the screening out the tail-order neighbor node of the object node and the previous-order neighbor node to the tail-order neighbor node comprises:
obtaining a preset meta-path, the preset meta-path including an adjacent node type; and
screening out the tail-order neighbor node of the object node and the previous-order neighbor node to the tail-order neighbor node from the multi-order neighbor nodes according to the adjacent node type.
